(19) United States
(12) Patent Application Publication
(10) Pub. No.: US 2008/0218670 A1
(43) Pub. Date: Sep. 11, 2008

(54) LIQUID CRYSTAL DEVICE AND ELECTRONIC APPARATUS

(75) Inventor: Yoshitomo KUMAI, Okaya-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/950,254

(22) Filed: Dec. 4, 2007

(30) Foreign Application Priority Data
Dec. 6, 2006 (JP) 2006-329693

(51) Int. Cl. G02F 1/1335

(52) U.S. Cl. 349/114

(57) ABSTRACT

A liquid crystal device of semi-transmissive reflective type includes a first substrate and a second substrate opposed to each other, a liquid crystal layer interposed therebetween, a pixel region having a reflection display region and a transmission display region, a first electrode having a plurality of strip electrode portions electrically connected to each other, a second electrode provided in the first substrate and facing the first electrode to produce an electric field between the first and the second electrodes, an electrode insulating film interposed between the first and the second electrodes, the electrodes and the electrode insulating film being arranged in a side of the first substrate toward the liquid crystal layer, a reflective polarizing layer for selectively reflecting a predetermined polarized light component of incident light, a light scatterer for scattering reflected light, and a layer for adjusting a thickness of the liquid crystal layer to make the thickness thereof in a light-scatterer formation region different from the thickness thereof in a light-scatterer non-formation region, the reflective polarizing layer, the light scatterer and the liquid-crystal-layer thickness adjusting layer being provided in the reflection display region.

### BACKGROUND

1. Technical Field

The present invention relates to a liquid crystal device and an electronic apparatus.

2. Related Art

Among various kinds of liquid crystal devices, there is known a liquid crystal device using a mode for controlling the alignment of liquid crystal molecules by applying an electric field to a liquid crystal layer in a substrate surface direction (It is hereinafter referred to as the “horizontal electric-field mode”). In accordance with the form of an electrode applying the electric field to the liquid crystal molecules, there are so-called known modes such as the in-plane switching (IPS) mode and the fringe-field switching (FFS) mode (e.g. See JP-A-2003-131248).

JP-A-2003-131248 is an example of related art.

Meanwhile, a mobile information terminal such as a mobile phone has been used in different luminous environments, and therefore, a display section thereof employs a semi-transmissive reflective liquid crystal device. Thus, the inventor of the present invention examined the display operation of a semi-transmissive reflective liquid crystal device that allows liquid crystal molecules to be driven by applying a horizontal electric field (or an oblique electric field). As a result, it was found out that the liquid crystal device of the above-mentioned IPS and FFS modes could not perform semi-transmissive reflective display just by providing a reflective layer in a pixel region.

### SUMMARY

Therefore, an advantage of the present invention is to provide a semi-transmissive reflective liquid crystal device of a horizontal electric field mode, which enables a high quality display in both of reflection and transmission displays.

In order to solve the above problem, a liquid crystal device of semi-transmissive reflective type according to a first aspect of the invention includes a first substrate and a second substrate opposed to each other, a liquid crystal layer interposed therebetween, a pixel region having a reflection display region and a transmission display region, a first electrode having a plurality of strip electrode portions electrically connected to each other, a second electrode provided in the first substrate and facing the first electrode to produce an electric field between the first and the second electrodes, an electrode insulating film interposed between the first and the second electrodes, the electrodes and the electrode insulating film being arranged in a side of the first substrate toward the liquid crystal layer, a reflective polarizing layer for selectively reflecting a predetermined polarized light component of incident light, a light scatterer for scattering reflected light, and a layer for adjusting a thickness of the liquid crystal layer to make the thickness thereof in a light scatterer formation region different from the thickness thereof in a light scatterer non-formation region, the reflective polarizing layer, the light scatterer and the liquid-crystal-layer thickness adjusting layer being provided in the reflection display region.

In the above structure, since the reflected light can be scattered by the light scatterer, the quality of reflection display can be improved in the semi-transmissive reflective liquid crystal device using the reflective polarizing layer, which usually does not have a light scattering mechanism. An operational mode is different between reflection displays using the reflective polarizing layer and an ordinary reflective layer (light scatterer), depending on whether a light reflecting member has a polarization selectivity or not Accordingly, it is impossible to obtain a normal display state only by simply providing the light scatterer in the pixel region. Thus, in the first aspect of the invention, the layer for adjusting the thickness of the liquid crystal layer is provided in the region that two-dimensionally overlaps with the light scatterer, where adjusting the thickness of the liquid crystal layer can eliminate an difference of display operation caused depending on the presence or absence of the above-mentioned polarization selectivity.

In the present specification, for example, in accordance with a case in which a color liquid crystal device includes a single pixel comprised of three sub pixels of red (R), green (G), and blue (B), a display region as a minimum unit for display is referred to as a “sub-pixel region”. Additionally, the “reflection display region” provided in the sub-pixel region is referred to as a region that enables display using a light input from a display surface side of the liquid crystal device, whereas the “transmission display region” is referred to as a region that enables display using a light input from a back surface side (a side opposed to the display surface) of the liquid crystal device.

Preferably, the light scatterer includes an insulating protrusion formed in the reflection display region and a reflecting film formed on a surface of the insulating protrusion. In this manner, the light scatterer can be formed in the reflection display region by a simple and easy process.

In addition, preferably, the light scatterer serves also as the thickness-adjusting layer for adjusting the thickness of the liquid crystal layer. In this manner, the liquid crystal device can be manufactured by an efficient manufacturing process at a low cost.

In addition, preferably, the light scatterer is formed in a non-formation region of the reflective polarizing layer in the reflection display region. In this manner, the reflective polarizing layer and the light scatterer are two-dimensionally partitioned, whereby a formation position of the light scatterer can be more freely set.

In addition, preferably, the light scatterer is formed partially on a side of the reflective polarizing layer toward the liquid crystal layer. In this manner, it is unnecessary to add any change to a shape of the reflective polarizing layer, which is therefore advantageous in terms of manufacturability.

In addition, preferably, a difference between a phase difference of the liquid crystal layer in the light scatterer formation region and a phase difference thereof in the light scatterer non-formation region is approximately ¼ of a wavelength λ of a light input to the pixel region. In this manner, linearly polarized light can be used in the reflection display using the reflective polarizing layer, whereas circularly polarized light can be used in the reflection display using the light scatterer. Thus, display optimization can be achieved by using the simple and easy structure.

In addition, preferably, a phase difference layer for giving a phase difference of approximately λ/4 to transmitted light is formed in a region of the second substrate two-dimensionally overlapping with the light scatterer. In this manner, a high light use efficiency can be obtained in both reflection displays using the light scatterer and the reflective polarizing layer. As a result, a bright reflection display can be achieved.

In addition, preferably, a phase difference plate for giving a phase difference of approximately λ/4 to transmitted light is provided in the second substrate on a side of the liquid crystal layer, whereas a phase difference layer for giving the phase difference of approximately λ/4 to the transmitted light is formed in the first substrate to be disposed toward the liquid crystal layer more than the reflective polarizing layer. In this manner, it is unnecessary to selectively arrange the phase difference layer (the phase difference plate) in the formation region of the light scatterer. This is an effective structure in terms of improvement of the manufacturability of the device.

In addition, preferably, the thickness of the liquid crystal layer in the light scatterer formation region is smaller than the thickness thereof in the light scatterer non-formation region. In this case, furthermore, preferably, the thickness of the liquid crystal layer in the light scatterer formation region is approximately ½ of the thickness thereof in the reflection display region in the light scatterer non-formation region.

In this manner, the liquid crystal device can perform a highly efficient reflection display by using the simple and easy structure.

In addition, preferably, the thickness of the liquid crystal layer in the transmission display region is approximately the same as the thickness thereof in the light scatterer non-formation region of the reflection display region. In this manner, display optimization can be easily performed in both of the transmission display region and the reflection display region using the reflective polarizing layer. Furthermore, no stepped portion is formed between the transmission and reflection display regions, thereby preventing the alignment disorder of liquid crystal molecules that may occur in the pixel region, so that a high contrast display can be obtained.

The reflective polarizing layer may be a metal film having a fine slit opening portion. Alternatively, the reflective polarizing layer may be a dielectric multilayer film formed by laminating a plurality of dielectric films each having a prism shape.

A liquid crystal device of semi-transmissive reflective type according to a second aspect of the invention includes a first substrate and a second substrate opposed to each other, a liquid crystal layer interposed therebetween, a pixel region having a reflection display region and a transmission display region, a first electrode having a plurality of strip electrode portions electrically connected to each other, a second electrode provided in the first substrate facing the first electrode to produce an electric field between the first and the second electrodes, an electrode insulating film interposed between the first and the second electrodes, the electrodes and the electrode insulating film being arranged on a side of the first substrate toward the liquid crystal layer, a reflective polarizing layer for selectively reflecting a predetermined polarized light component of incident light and a reflective layer for reflecting the incident light, the reflective polarizing layer and the reflective layer being formed to be partitioned in the reflection display region, and a thickness of the liquid crystal layer in a formation region of the reflective polarizing layer being different from the thickness thereof in a formation region of the reflective layer.

In this manner, the liquid crystal device can easily perform both reflection displays using the reflective polarizing layer and the reflective layer in the reflection display region. It is more difficult to form a reflective polarizing layer than an ordinary reflecting film, and therefore, its formation position, shape and forming method are often limited. Accordingly, in the second aspect of the invention, the formation region of the ordinary reflective layer is provided in the reflection display region. Additionally, in order to eliminate a display mode difference between the reflection displays using the reflective polarizing layer and the reflective layer, the thickness of the liquid crystal layer above the reflective layer is made different from that the thickness thereof above the other regions. This manner enables formation of the reflective polarizing layer or the like while ensuring the brightness of the reflection display. Accordingly, it is possible to more flexibly design and manufacture the semi-transmissive reflective liquid crystal device including the reflective polarizing layer.

In addition, in the liquid crystal device of the second aspect, a dielectric protrusion as a layer for adjusting the thickness of the liquid crystal layer may be formed in the first substrate so as to correspond to the formation region of the reflective layer. In this manner, the thickness of the liquid crystal layer can be adjusted easily and accurately.

In addition, preferably, the reflective layer is a light scatterer that produces scatteredly reflected light. In this manner, visibility can be improved by its light scattering mechanism.

Preferably, in one of the first and the second substrates that forms a display surface of the liquid crystal device, a polarizing plate is provided on a surface of the substrate on the opposite side from the liquid crystal layer, and the transmission axis of the polarizing plate is arranged approximately parallel to the transmission axis of the reflective polarizing layer. In this manner, the transmittance/reflectance of a light input to the reflective polarizing layer can be maximized, thereby obtaining a bright display.

Preferably, the strip electrode portions of the first electrode are arranged approximately parallel to each other and extended in a direction intersecting with the transmission axis of the reflective polarizing layer. In this manner, when a voltage is applied between the electrodes, the alignment directions of liquid crystal molecules can be dispersed on the substrate surface, so that a visual angle of display can be easily widened.

Preferably, the extending direction of the strip electrode portions and the transmission axis of the reflective polarizing layer forms an angle of approximately 30 degrees. With the angle of 30 degrees, a viewing zone angle can be enlarged while reducing the movement of liquid crystal molecules due to the voltage application between the electrodes.

The reflective polarizing layer may be formed partially in the pixel region. In the liquid crystal device structured in this manner, the reflection display region of the pixel region is a region where the reflective polarizing layer is partially formed, and the transmission display region thereof is the remaining region where the reflective polarizing layer is not formed. In this case, the transmission display region and the reflection display region are clearly partitioned. Thus, an optical design can be optimized in each of the reflection display and the transmission display, which is advantageous in terms of manufacturing a liquid crystal display with a higher image quality.

Alternatively, the reflective polarizing layer may be formed on an approximately entire surface of the pixel region. In the liquid crystal device structured in this manner, the reflective polarizing layer transmits a part of an incident polarized light component and reflects another part thereof. Since the reflective polarizing layer can be formed in the continuous pattern in the pixel region, the liquid crystal device can be excellent in that the device can be easily manufactured with a good yield. Furthermore, the pixel region in the structure can be used more widely than the case where the pixel region is partitioned into the reflection display region and the transmission display region, thereby facilitating the optical design of pixels.

In addition, the reflective polarizing layer may be electrically connected to the first electrode. In this manner, the reflective polarizing layer can be used as an additional electrode for applying a voltage to the liquid crystal.

Furthermore, an illuminating device may be arranged on an outer surface of the first substrate. In the liquid crystal device of each of the above aspects, the first substrate includes the reflective polarizing layer for performing the reflection display and the first and the second electrodes for driving the liquid crystal molecules. Accordingly, the liquid crystal device can be manufactured in such a manner that the first substrate is not arranged at the display surface side. If the first substrate is arranged there, outer light is diffusedly reflected by a metal wire or the like that is provided on the first substrate to supply a driving signal to the first and the second electrodes, resulting in deterioration of the visibility of the liquid crystal device. However, in the liquid crystal device described above, there occurs no diffused reflection of outer light, so that an excellent visibility can be obtained.

In addition, preferably, between the first substrate and the illuminating device is provided a polarizing plate having a transmission axis arranged in a direction approximately orthogonal to the transmission axis of the reflective polarizing layer. In this manner, the use efficiency of an illumination light input from the illuminating device can be maximized, thereby obtaining a bright transmission display.

Preferably, one of the first and the second substrates includes a color filter, which is partitioned into a plurality of planar regions having different chromaticities in the sub-pixel region. In this manner, in each of the reflection display region and the transmission display region, it is possible to provide a color display with an appropriate chromaticity, whereby the liquid crystal device can achieve a clearer color reproduction and a higher image quality.

An electronic apparatus according to a third aspect of the invention includes the liquid crystal device according to one of the first and the second aspects of the invention. In this manner, the electronic apparatus can include a display section enabling the transmission and reflection displays with a high luminance, a high contrast, and a wide viewing angle.

### BRIEF DESCRIPTION OF THE DRAWINGS

The invention will be described with reference to the accompanying drawings, wherein like numbers reference like elements.

FIG. 1 shows an equivalent circuit diagram of a liquid crystal device according to a first embodiment of the invention.

FIGS. 2A and 2B show the planar structure of a single sub-pixel region and the arrangement of optical axes of optical elements in the liquid crystal device.

FIG. 3 shows a sectional view taken along line A-A′ of FIG. 2A.

FIGS. 4A and 4B illustrate a reflective polarizing layer.

FIG. 5 illustrates an operation of the liquid crystal device according to the first embodiment.

FIG. 6 shows a modified example of the liquid crystal device according to the first embodiment.

FIGS. 7A and 7B show a single sub-pixel region and the arrangement of optical axes of optical elements in a liquid crystal device according to a second embodiment of the invention.

FIG. 8 shows a sectional view taken along line B-B′ of FIG. 7A.

FIGS. 9A and 9B illustrate a reflective polarizing layer.

FIG. 10 illustrates an operation of the liquid crystal device according to the second embodiment.

FIG. 11 shows a single sub-pixel region and the arrangement of optical axes of optical elements in a liquid crystal display according to a third embodiment of the invention.

FIG. 12 shows a sectional view taken along line D-D′ of FIG. 1.

FIG. 13 shows an equivalent circuit diagram of a liquid crystal device according to a fourth embodiment of the invention.

FIG. 14 shows a sub-pixel region in the liquid crystal device according to the fourth embodiment.

FIG. 15 shows a sectional view taken along line F-F′ of FIG. 14.

FIG. 16 shows a sub-pixel region in a liquid crystal device according to a fifth embodiment of the invention.

FIG. 17 shows a sectional view taken along line G-G′ of FIG. 16.

FIG. 18 illustrates an operation of the liquid crystal device according to the fifth embodiment.

FIG. 19 shows an example of an electronic apparatus.

### DESCRIPTION OF EXEMPLARY EMBODIMENTS

Exemplary embodiments of the invention will be described based on the drawings.

### First Embodiment

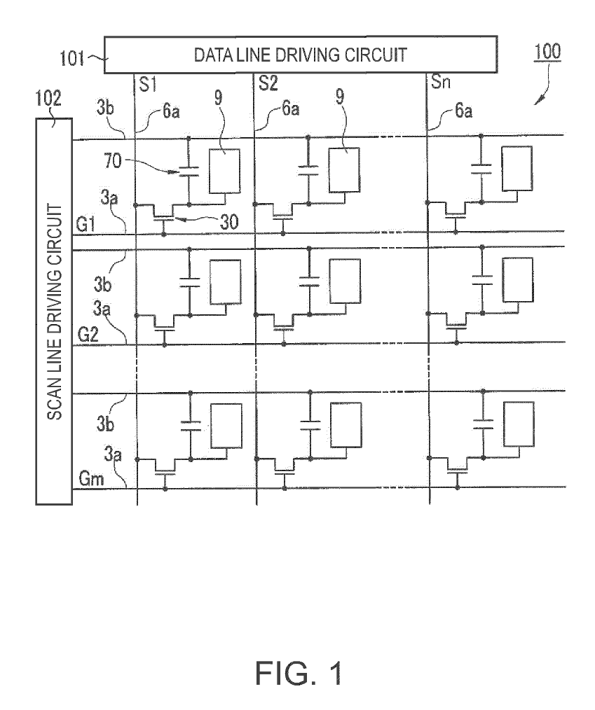

Hereinafter, a liquid crystal device according to a first embodiment of the invention will be described with reference to FIGS. 1 to 6. The liquid crystal device of the first embodiment employs the so-called fringe-field switching (FFS) mode, which is one of the horizontal electric field modes performing display by applying an electric field having a substrate surface direction (a horizontal electric field) to liquid crystal molecules to control the alignment thereof. Additionally, the liquid crystal device of the present embodiment is also a color liquid crystal device including a color filter formed on a substrate, where a single pixel is comprised of three sub-pixels outputting color light of red (R), green (G) and blue (B). Accordingly, a display region as a minimum unit of display is referred to as a “sub-pixel region”, and a display region comprised of a single set of the sub-pixels (R, G, and B) is referred to as a “pixel region”.

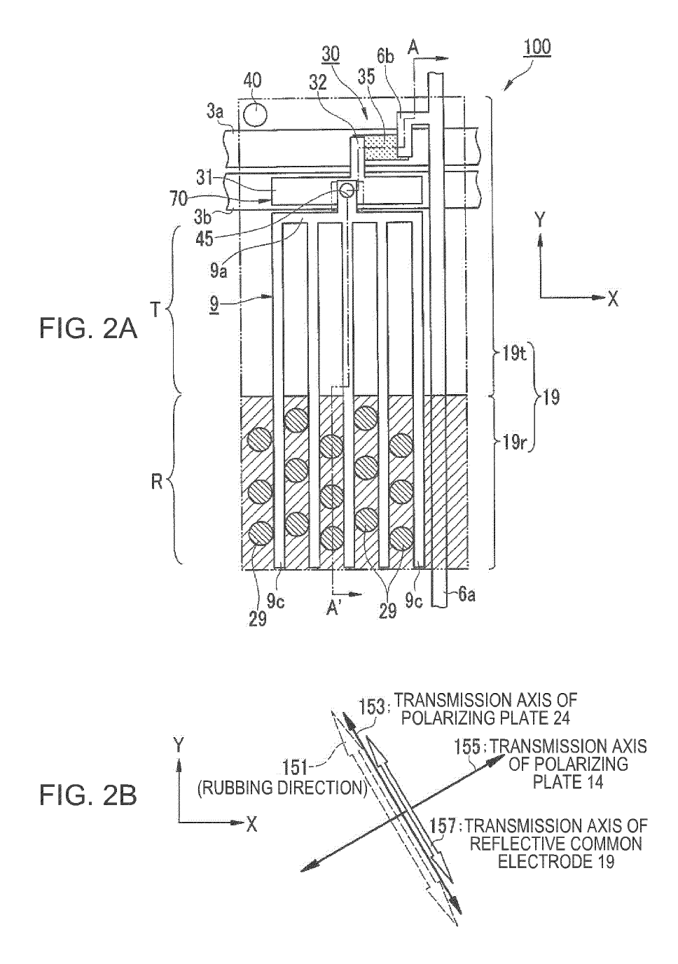

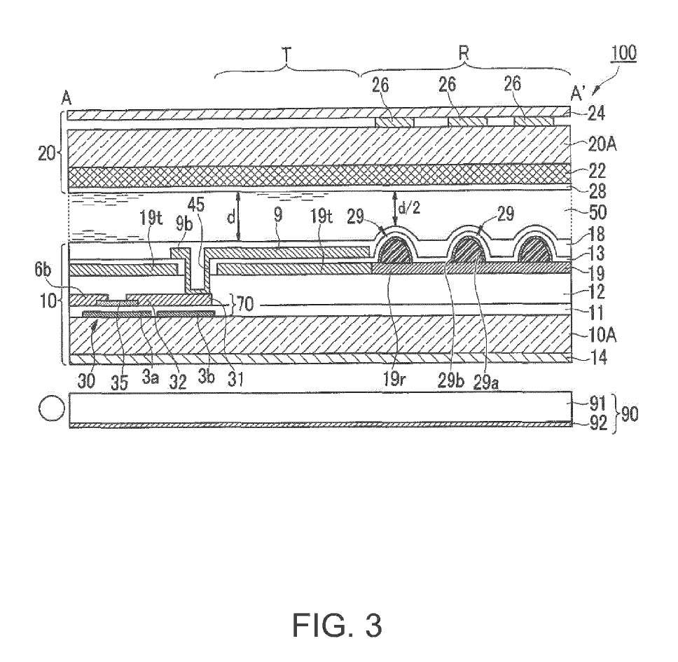

FIG. 1 is an equivalent circuit diagram showing a plurality of sub-pixel regions formed in a matrix, which are included in a liquid crystal device 100 of the first embodiment. FIG. 2A is a plan view showing an arbitrary single sub-pixel region of the liquid crystal device 100. FIG. 2B is an illustrative view showing an arrangement relationship between the optical axes of optical elements included in the liquid crystal device 100. FIG. 3 is a partial sectional view taken along line A-A′ of FIG. 2A.

Among the drawings, layers and members are shown in different scales so as to make them recognizable in each of the drawings.

As shown in FIG. 1, in each of the sub-pixel regions formed in the matrix, which constitutes the image display region of the liquid crystal device 100, there are formed a pixel electrode 9 and a thin film transistor (TFT) 30 performing switching control of the pixel electrode 9. A source of the TFT 30 is electrically connected to a data line 6a extending from a data line driving circuit 101, which supplies each of image signals S1, S2 to Sn to each pixel via each data line 6a. The image signals S1 to Sn may be supplied line by line in the sequential order or may be supplied to each group of the data lines 6a adjacent to each other.

A gate of the TFT 30 is electrically connected to a scan line 3a extending from the scan line driving circuit 102. Each of scan signals G1, G2 to Gm is supplied as a pulse to the scan line 3a at a predetermined timing from the scan line driving circuit 102 to be applied to the gate thereof line by line in the sequential order. The pixel electrode 9 is electrically connected to a drain of the TFT 30. When the TFT 30 as a switching element is placed in an ON state only during a predetermined period of time by inputting the scan signals G1, G2 to Gm, the image signals S1, S2 to Sn supplied from the data line 6a are written into the pixel electrode 9 at a predetermined timing.

The image signals S1, S2 to Sn having a predetermined level are written in the liquid crystal via the pixel electrode 9 to be stored, during a certain period of time, between the pixel electrode 9 and the common electrode opposed thereto via the liquid crystal interposed therebetween. In the present embodiment, in order to prevent leakage of the stored image signals, a storage capacitance 70 is added parallel to a liquid crystal capacitance formed between the pixel electrode 9 and the common electrode. The storage capacitance 70 is provided between the drain of the TFT 30 and a capacitance line 3b.

Next, a detailed structure of the liquid crystal device 100 will be described by referring to FIGS. 2A, 2B and FIG. 3. The liquid crystal device 100 includes a liquid crystal panel that sandwiches a liquid crystal layer 50 between a TFT array substrate (a first substrate) 10 and an opposing substrate (a second substrate) 20, as shown in FIG. 3. The liquid crystal layer 50 is sealed between the substrates 10 and 20 by a sealing material (not shown) provided along an edge of a region where the TFT array substrate 10 and the opposing substrate 20 face each other. On a back surface side of (a lower surface side in the drawing) of the TFT array substrate 10 is provided a backlight (illuminating device) 90 including a light guiding plate 91 and a reflecting plate 92.

As shown in FIG. 2A, in the sub-pixel region of the liquid crystal device 100 are provided a pixel electrode (a first electrode) 9 having a longitudinal comb-teeth-like shape in a planar view in an extending direction (Y-axis direction) of the data line 6a and a common electrode (a second electrode) 19 having a planar and approximately continuous shape that is two-dimensionally arranged overlapping with the pixel electrode 9. At an upper left corner of the sub-pixel region in FIG. 2A is erected a columnar spacer 40 by which the TFT array substrate 10 and the opposing substrate 20 are retained spaced apart from each other by a predetermined distance.

The pixel electrode 9 includes a plurality of strip electrode portions 9c (five electrode portions 9c in the drawing) extending in the Y-axis direction, a base end portion 9a connected to each end of the strip electrode portions 9c located toward the TFT 30 (+Y side) and extended in an extending direction of the scan line 3a, and a contact portion 9b elongated from a center of the base end portion 9a in the extending direction of the scan line 3a toward the TFT 30 (+Y side).

The common electrode 19 is partitioned into a transparent common electrode 19t and a reflective common electrode 19r in the pixel region shown in FIG. 2A. In the entire image display region, the transparent common electrode 19t and the reflective common electrode 19r extending in the extending direction of the scan line 3a (X-axis direction) are alternately arranged relative to the extending direction of the data line 6a (Y-axis direction). In the present embodiment, the transparent common electrode 19t is a conductive film made of a transparent conductive material such as indium tin oxide (ITO). The reflective common electrode 19r is a reflective polarizing layer made of a light-reflective metal film with a fine slit structure, although a detail thereof will be described later.

The common electrode 19 may have an approximately rectangular shape in a planar view, and it is approximately equal to the size of the sub-pixel region shown in FIG. 2A. In this case, there may be provided a common electrode wire extending across the plurality of common electrodes to electrically connect the common electrodes arranged in an extending direction of the common electrode wire.

Additionally, in a formation region of the reflective common electrode 19r are formed a plurality of light scatterers 29, each of which is an approximately dome-shaped (approximately hemispherical) protrusion having a light reflective surface and serves also as a layer for adjusting the thickness of a liquid crystal layer. The light scatterers 29 each have a diameter of approximately 8 to 10 μm and a height of approximately 0.5 to 1 μm.

Preferably, the light scatterers 29 are arranged at random in the formation region of the refection common electrode 19r. Additionally, the light scatterers 29 may have mutually different diameters. The structure can prevent interference of lights reflected by the light scatterers 29, thereby improving the visibility of reflection display.

At the TFT 30 are formed the data line 6a extending in a longitudinal direction of the pixel electrode 9 (X-axis direction), the scan line 3a extending in the direction orthogonal to the data line 6a (Y-axis direction), and a capacitance line 3b that is adjacent to the scan line 3a and extends parallel thereto. The TFT 30 is disposed near an intersection of the data line 6a and the scan line 3a. The TFT 30 includes a semiconductor layer 35 made of an amorphous silicon film formed partially in a planar region of the scan line 3a, a source electrode 6b and a drain electrode 32 formed partially and two-dimensionally overlapping with the semiconductor layer 35. The scan line 3a serves as a gate electrode of the TFT 30 at a position where the line two-dimensionally overlaps with the semiconductor layer 35.

The source electrode 6b of the TFT 30 is branched from the data line 6a to be extended to the semiconductor layer 35, thereby being formed into an approximately reversed-L shape in a planar view. The drain electrode 32 is elongated from the position where the electrode two-dimensionally overlaps with the semiconductor layer 35 to the pixel electrode 9 (−Y side), and a tip of the drain electrode 32 is electrically connected to a capacitance electrode 31 having an approximately rectangular shape in a planar view. On the capacitance electrode 31 is arranged the contact portion 9b protruding toward the scan line 3a at an end portion of the pixel electrode 9. The capacitance electrode 31 and the pixel electrode 9 are electrically connected to each other by a pixel contact hole 45 formed at a position where the electrodes 31 and 9 two-dimensionally overlap with each other. The capacitance electrode 31 is arranged in a planar region of the capacitance line 3b to form the storage capacitance 70 between the capacitance electrode 31 and the capacitance line 3b, which face each other in a thickness direction thereof.

The liquid crystal device 100 of the present embodiment is an FFS-mode liquid crystal device including the pixel electrode 9 and the common electrode 19 opposing thereto. Accordingly, when a voltage is applied to the pixel electrode 9 to operate the display panel, a relatively large capacitance is formed in the region where the pixel electrode 9 two-dimensionally overlaps with the common electrode 19. Thus, in the liquid crystal device 100, the storage capacitance 70 may be omitted. This allows a formation region of the capacitance electrode 31 and the capacitance line 3b to be used also for display, thereby improving a sub-pixel aperture ratio to increase the brightness of display.

Next, in the sectional structure shown in FIG. 3, the liquid crystal layer 50 is sandwiched between the TFT array substrate 10 and the opposing substrate 20 facing each other. The TFT array substrate 10 includes a base that is a translucent substrate main body 10A made of glass, quartz or plastic. On an internal surface of the substrate main body 10A (on the surface thereof toward the liquid crystal layer 50) are formed the scan line 3a and the capacitance line 3b. Additionally, there is formed a gate insulating film 11 made of a transparent insulating film of silicon oxide or the like to cover the scan line 3a and the capacitance line 3b.

On the gate insulating film 11 is formed the amorphous silicon semiconductor layer 35. The source electrode 6b and the drain electrode 32 are provided so as to be partially placed on the semiconductor layer 35. The capacitance electrode 31 is formed integrally with the drain electrode 32.

The semiconductor layer 35 is disposed so as to face the scan line 3a with the gate insulating film 11 interposed therebetween. In the facing region thereof, the scan line 3a forms the gate electrode of the TFT 30. The capacitance electrode 31 is disposed so as to face the capacitance line 3b with the gate insulating film 11 interposed therebetween. In the region where the capacitance electrode 31 faces the capacitance line 3b, there is formed the storage capacitance 70 having the gate insulating film 11 as a dielectric film thereof.

In order to cover the semiconductor layer 35, the source electrode 6b, the drain electrode 32 and the capacitance electrode 31, there is formed an interlayer insulating film 12 made of silicon oxide or the like. On the interlayer insulating film 12 is formed the common electrode 19 comprised of the transparent common electrode 19t made of the transparent conductive material such as ITO and the reflective common electrode 19r (reflective polarizing layer) mainly made of a reflective metal film such as aluminum. The transparent common electrode 19t and the reflective common electrode 19r are electrically connected to each other. Accordingly, in the liquid crystal device 100 of the first embodiment, in the single sub-pixel region shown in FIG. 2A, a formation region of the transparent common electrode 19, which is situated in the approximately rectangular planar region where the pixel electrode 9 is arranged, is referred to as a transmission display region T, where display is performed by modulating light input from the backlight 90 and then transmitted through the liquid crystal layer 50. In addition, in the planar region where the pixel electrode 9 is arranged, a formation region of the reflective common electrode 19r is referred to as a reflection display region R, where display is performed by reflecting and modulating light input from an outside of the opposing substrate 20 and then transmitted through the liquid crystal layer 50.

FIGS. 2A, 2B and FIG. 3 show the situation in which the transparent common electrode 19t and the reflective common electrode 19r included in the common electrode 19 are two-dimensionally partitioned. However, the transparent common electrode 19t may be elongated up to a position covering the reflective common electrode 19r. In this manner, the transparent common electrode 19t will be disposed evenly on a surface of the common electrode 19 facing the pixel electrode 9. Accordingly, an electric field produced between the pixel electrode 9 and the common electrode 19 can be equalized in the sub-pixel region.

On the reflective common electrode 19r are formed the plurality of light scatterers 29. Each of the light scatterers 29 includes an insulating protrusion 29a, which is made of a resin material or the like and has the approximately dome-like (approximately hemispherical) shape, and a reflective layer 29b covering a surface of the insulating protrusion 29a. The reflective layer 29b may be a thin film made of a light-reflective metal material such as aluminum or silver.

The above-described light scatterers 29 may be formed by using the following manufacturing process.

First, a photosensitive resin material is applied on the reflective common electrode 19r. An applied film made of the photosensitive resin is subjected to exposure and development to form a columnar protrusion on the reflective common electrode 19r. Thereafter, heating is performed to blunt the corners of the columnar protrusion to form it into an approximately dome-like shape, thereby producing the insulating protrusions 29a. Then, after a metal coat film made of aluminum or the like is formed by vapor deposition or the like, portions where the light scatterers 29 are supposed to be formed are masked to remove the metal coat film by various kinds of etching or the like, thereby forming the reflective layers 29b to cover the insulating protrusions 29a.

In FIG. 3, the light scatterers 29 are formed directly on the reflective common electrode 19r. Instead of that, the electrode 19r may be electrically connected to the reflective layer 29b of each light scatterer 29. Additionally, when the transparent common electrode 19t is elongated so as to cover the reflective common electrode 19r, the electrode 19t may be electrically connected to each of the reflective layers 29b.

In order to cover the common electrode 19 and the light scatterers 29, there is formed an electrode insulating film 13 made of silicon oxide or the like, on which there is formed the pixel electrode 9 made of the transparent conductive material such as ITO. A pixel contact hole 45 penetrates through the interlayer insulating film 12 and the electrode insulating film 13 to reach the capacitance electrode 31. The contact portion 9b of the pixel electrode 9 is partially embedded in the pixel contact hole 45 to electrically connect the pixel electrode 9 and the capacitance electrode 31. Additionally, an opening portion is formed also in the common electrode 19 so as to correspond to a formation region of the pixel contact hole 45, so that the common electrode 19 is not brought into contact with the pixel electrode 9. An alignment film 18 made of polyimide or the like is formed so as to cover the pixel electrode 9.

In FIGS. 2A, 2B and FIG. 3, for a better understanding of the drawings, the light scatterers 29 and the pixel electrode 9 are arranged so as not to two-dimensionally overlap with each other. However, a part of the pixel electrode 9 may be formed on the light scatterers 29.

Meanwhile, on an internal surface side of the opposing substrate 20 (on the side thereof toward the liquid crystal layer 50) are laminated a color filter 22 and an alignment film 28. Partially on an outer surface side thereof are formed a plurality of phase difference plates 26. Additionally, a polarizing plate 24 is arranged so as to cover the phase difference plates 26, which give a phase difference of approximately λ/4 to transmitted light and are selectively disposed at positions facing the light scatterers 29 in a thickness direction of the liquid crystal layer 50 such that the positions of the plates correspond to the formation positions of the light scatterers 29.

Preferably, the color filter 22 is formed so as to be partitioned into two regions having different color levels in the pixel region. As a concrete example, a structure can be employed in which the color filter 22 is partitioned into a first color material region and a second color material region. The first region is arranged to correspond to the planar region of the transparent common electrode 19t forming the transmission display region, whereas the second region is arranged to correspond to the planar region of the reflective common electrode 19r forming the reflection display region. In this case, the first color material region arranged in the transmission display region has a color density greater than that of the second color material region. This manner can prevent the unevenness of color of display light appearing between the transmission display region where the display light is transmitted through the color filter 22 only once and the reflection display region where the light is transmitted therethrough twice. Thus, equal visual quality can be maintained in the reflection display and the transmission display, thereby improving display quality.

In the above structure, as shown in FIG. 3, since the light scatterers 29 each having the insulating protrusion 29a are formed, a surface side of the TFT array substrate 10 situated toward the liquid crystal layer 50 is protruded toward the liquid crystal layer 50 in the formation region of each light scatterer 29. As the result of formation of the protrusion, the thickness of the liquid crystal layer 50 in the formation region of the light scatterer 29 is smaller than that of the liquid crystal layer 50 in the region without the light scatterers 29 (a non-formation region). In the present embodiment, a mean thickness of the liquid crystal layer 50 in the formation region of each light scatterer 29 is made to be approximately ½ of a layer thickness “d” in the other regions. As described here, the light scatterer 29 in the present embodiment serves also as the layer for adjusting the thickness of the liquid crystal layer, where the thickness of the scatterer itself (a height of the protruded portion) makes the thickness of the liquid crystal layer 50 different from the thickness thereof in the other regions.

In the present embodiment, the light scatterer 29 serves as the layer for adjusting the thickness of the liquid crystal layer. However, the liquid-crystal-layer thickness adjustment layer may be provided independently from the light scatterer 29. For example, a resin layer may be formed selectively on the reflective common electrode 19r and then the light scatterer 29 may be formed on the resin layer, so that the thickness of the resin layer may be used to adjust the thickness of the liquid crystal layer. Alternatively, the resin layer serving as the liquid-crystal-layer thickness adjustment layer may be laminated on the light scatterer 29.

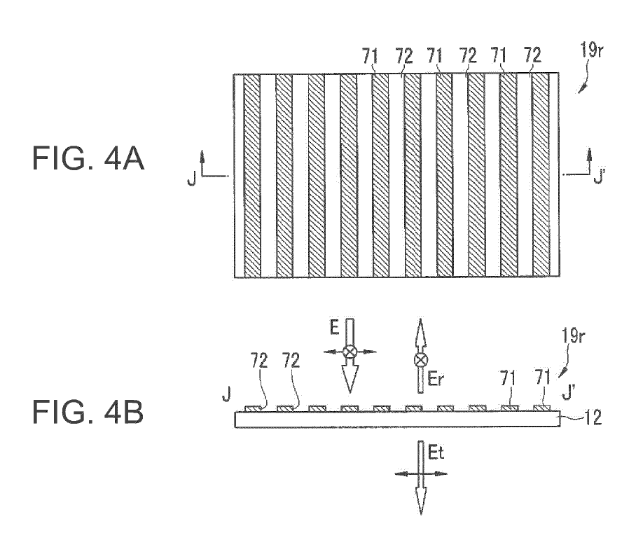

FIGS. 4A and 4B illustrate a structure of the reflective common electrode 19r as the reflective polarizing layer and a mechanism thereof. FIG. 4A is a plan view of the reflective common electrode 19r and FIG. 4B is a side surface view taken along line J-J′ of FIG. 4A.

As shown in FIGS. 4A and 4B, the reflective common electrode 19r is mainly formed of a metal film 71 made of a light-reflective metal such as aluminum. The metal film 71 includes a plurality of fine slits (opening portions) 72 having a strip shape in a planar view and formed at a predetermined pitch therebetween on the metal film 71. The plurality of slits 72 are provided parallel to each other with an equal width. Each slit 72 has a width of approximately 30 to 300 nm. Since the slits 72 are formed with the predetermined pitch, the metal film 71 formed into narrow lines also has a line width ranging from approximately 30 to 300 nm.

As shown in FIG. 4B, when a light E is input from an upper surface side of the reflective common electrode 19r formed as described above, the electrode 19r reflects a polarized component parallel to a length direction of the slit 72 as a reflected light Er and transmits a polarized component parallel to a width direction of the slit 72 as a transmitted light Et. In other words, the reflective common electrode 19r has a reflection axis parallel to the extending direction of the slit 72 and a transmission axis in the direction orthogonal to the reflection axis.

Regarding the reflective common electrode 19r of the liquid crystal device 100, as shown in the arrangement diagram of optical axes in FIG. 2B, a transmission axis (direction orthogonal to the extending direction of the slit 72) 157 of the electrode 19r is arranged parallel to a transmission axis 153 of the polarizing plate 24 situated closer to the opposing substrate 20 and orthogonal to the transmission axis 155 of the polarizing plate 14 included in the TFT array substrate 10. Additionally, in the liquid crystal device 100 of the present embodiment, alignment films 18 and 28 are subjected to rubbing treatment in the same direction in a planar view, and the direction is referred to as a rubbing direction 151 shown in FIG. 2B. Thus, the transmission axis 157 of the reflective common electrode 19r is parallel to the rubbing direction 151 of the alignment films 18 and 28.

The rubbing direction 151 is set as a direction forming an angle of approximately 30 degrees relative to the extending direction (Y-axis direction) of the strip electrode portions 9c of the pixel electrode 9. Additionally, in the present embodiment, a rubbing treatment is used to control an initial alignment direction of liquid crystal molecules, although another alignment control method may be used. Even in the case of using an inorganic alignment film, the alignment control direction is the same as the rubbing direction 151.

The liquid crystal device 100 structured as above is the FFS-mode liquid crystal device. Thus, when an image signal (voltage) is applied to the pixel electrode 9 via the TFT 30, an electric filed is produced between the pixel electrode 9 and the common electrode 19 in the substrate surface direction (X-axis direction in FIG. 2 in the planar view). Then, the liquid crystal molecules are driven by the electric field to change the transmittance/reflectance of each sub-pixel, thereby performing image display.

As shown in FIG. 2B, the alignment films 18 and 28, which are opposed to each other while sandwiching the liquid crystal layer 50 therebetween, are subjected to rubbing treatment in the same direction in the planar view. Thus, in a state in which no voltage is applied to the pixel electrode 9, the liquid crystal molecules included in the liquid crystal layer 50 remain aligned horizontally in the rubbing direction 151 between the substrates 10 and 20. When the electric field produced between the pixel electrode 9 and the common electrode 19 is applied to the liquid crystal layer 50 having the liquid crystal molecules aligned in the above state, the liquid crystal molecules are brought into alignment in the line width direction (X-axis direction) of each of the strip electrode portions 9c shown in FIG. 2A. The liquid crystal device 100 takes advantage of double refraction based on such different alignment states of the liquid crystal molecules to perform bright and dark displays. When the liquid crystal device 100 operates, it is only necessary to maintain a voltage of the common electrode 19 at a certain level imposed to cause a voltage difference within a predetermined range between the common electrode 19 and the pixel electrode 9.

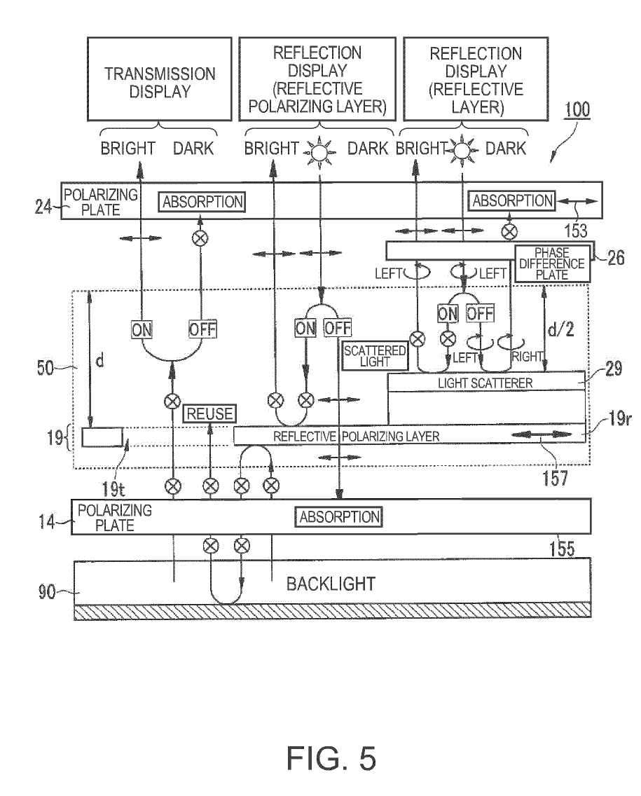

Next, the operation of the liquid crystal device 100 structured as above will be described by referring to FIG. 5. FIG. 5 is an illustrative view on how the liquid crystal device 100 is operated. The drawing shows only components necessary for the description. Sequentially from the upper side in FIG. 5 (panel display surface side), there are shown the polarizing plate 24, the phase difference plate 26, the liquid crystal layer 50, the light scatterer 29, the common electrode 19, the polarizing plate 14 and the backlight 90.

First will be described a transmission display (transmission mode) using the transmission display region T shown in FIGS. 2A, 2B and FIG. 3.

As shown in the “transmission display” on the left in FIG. 5, in the liquid crystal device 100, light emitted from the backlight 90 is transmitted through the polarizing plate 14, whereby the light becomes a linearly polarized light having a vibration direction parallel to the transmission axis 155 of the polarizing plate 14 to be input to the liquid crystal panel. The light input to the liquid crystal panel is transmitted through the transparent common electrode 19t of the common electrode 19 to be input to the liquid crystal layer 50. Then, when the liquid crystal layer 50 is in an ON state (where a selected voltage is applied between the pixel electrode 9 and the common electrode 19), the light crystal layer 50 gives a predetermined phase difference (λ/2) to the incident light, which in turn is changed to linearly polarized light having a vibration direction parallel to the transmission axis 153 of the polarizing plate 24. As a result, the light transmitted through the polarizing plate 24 is visually recognized as display light, thereby causing the sub-pixels to provide a bright display.

Meanwhile, when the liquid crystal layer 50 is in an OFF state (where the selected voltage is not applied), the incident light reaches the polarizing plate 24 while maintaining its polarized state to be absorbed by the polarizing plate 24 having an absorption axis parallel to the incident light (an optical axis orthogonal to the transmission axis 153), thereby causing the sub-pixels to provide a dark display.

Additionally, among light transmitted through the polarizing plate 14, a light input to the reflective common electrode 19r is reflected by the reflective common electrode 19r having a reflection axis parallel to the linearly polarized light. Thus, the reflected light is not input to the liquid crystal layer 50 but returned to the backlight 90. Since the reflected light is the linearly polarized light having the vibration direction parallel to the transmission axis 155 of the polarizing plate 14, it is transmitted through the polarizing plate 14 to reach the reflecting plate 92 of the backlight 90, resulting in being repeatedly reflected between the reflecting plate 92 and the reflective common electrode 19r. When the repeatedly reflected light is input to the transparent common electrode 19t, the light can be used as display light for the transmission display. Accordingly, a light use efficiency of the backlight 90 can be increased, thereby improving the luminance of the transmission display.

Next will be described a reflection display using the reflective common electrode (reflective polarizing layer) 19r shown in FIGS. 2A, 2B and FIG. 3.

In the reflection display of a part shown as “reflection display (reflective polarizing layer)” at a center in FIG. 5, a light input from the upper side (panel display surface side) of the polarizing plate 24 to the liquid crystal panel is transmitted through the polarizing light plate 24. Then, the light is changed to a linearly polarized light parallel to the transmission axis 153 of the polarizing plate 24 to be input to the liquid crystal layer 50. In this situation, when the liquid crystal layer 50 is in the ON state, the liquid crystal layer 50 gives the predetermined phase difference (λ/2) to the incident light, whereby the light is changed to linearly polarized light having a vibration direction orthogonal to the incident direction to be input to the reflective common electrode 19r. In this case, as shown in FIG. 2B, the reflective common electrode 19r as the reflective polarizing layer has the transmission axis 157 parallel to the transmission axis 153 of the polarizing plate 24 and the reflection axis orthogonal thereto. Thus, the light, which is transmitted through the liquid crystal layer 50 in the ON state and input to the reflective common electrode 19r, is reflected while maintaining its polarized state. The reflected light is input again to the liquid crystal layer 50 and returned to the polarized state it had upon incidence (the state of the linearly polarized light having the vibration direction parallel to the transmission axis of the polarizing plate 24) by the mechanism of the liquid crystal layer 50 to be input to the polarizing plate 24. Then, the reflected light transmitted through the polarizing plate 24 is visually recognized as display light, thereby causing the sub-pixels to provide a bright display.

Meanwhile, when the liquid crystal layer 50 is in the OFF state, the light input from the polarizing plate 24 to the liquid crystal layer 50 is input to the reflective common electrode 19r while maintaining its polarized state and then transmitted through the reflective common electrode 19r having the transmission axis 157 parallel to the incident light. Thereafter, the transmitted light is absorbed by the polarizing plate 14 having an absorption axis parallel to the transmitted light (transmission axis orthogonal thereto), thereby causing the sub-pixels to provide a dark display.

Next will be described a reflection display using the light scatterers 29 (reflective layers 29b) shown in FIGS. 2A, 2B and FIG. 3.

In the reflection display of a part shown as “reflection display (reflective layer)” on the right side in FIG. 5, a light input to the liquid crystal panel from the upper side (panel display surface side) of the polarizing plate 24 is transmitted through the polarizing plate 24. Thereby, the light is changed to a linearly polarized light having the vibration direction parallel to the transmission axis 153 and then transmitted through the phase difference plate 26 to be changed to a counterclockwise circularly polarized light and input to the liquid crystal layer 50. In this case, in the formation region of each of the light scatterers 29, the thickness of the liquid crystal layer 50 is partially reduced due to the thickness of the insulating protrusion 29a to become a thickness d/2 as an approximately half of the thickness “d” of the other regions (including the transmission display region T and the formation region of the reflective common electrode 19r). Accordingly, when the liquid crystal layer 50 is in the ON state, a phase difference given to the incident light by the liquid crystal layer 50 is λ/4 as a half wavelength of the light input to the reflective common electrode 19r. Thereby, the incident light is changed to linearly polarized light having the vibration direction orthogonal to the transmission axis 153 of the polarizing plate 24 to be input to the light scatterer 29 (reflective layer 29b). The linearly polarized light is reflected while maintaining its polarized state to become light scattered due to a protruded shape of the reflective layer 29b. Thereafter, the reflected light is input again to the liquid crystal layer 50 to be changed to counterclockwise circularly polarized light by the mechanism of the liquid crystal layer 50 and then input to the phase difference plate 26. The light transmitted through the phase difference plate 26 is changed to linearly polarized light having the vibration direction parallel to the transmission axis 153 of the polarizing plate 24 to be transmitted through the plate. Thereby, the reflected light transmitted therethrough is visually recognized as display light, thereby causing the sub-pixels to provide a bright display. A part of the reflected light is scattered by the light scatterer 29. Accordingly, in the liquid crystal device 100, the distribution of a reflected light intensity is not deviated in a particular direction, thereby providing a highly visual display.

Meanwhile, when the liquid crystal layer 50 is in the OFF state, the light input from the phase difference plate 26 to the liquid crystal layer 50 is input to the light scatterer 29 while maintaining its polarized state and reflected by the reflective layer 29b. At that time, a traveling direction of the incident light as a counterclockwise circularly polarized light is reversed. Consequently, a rotation direction of the light when viewed from the polarizing plate 24 is reversed, whereby the light is changed to clockwise circularly polarized light to be input again to the liquid crystal layer 50. Then, the light transmitted through the layer is input to the phase difference plate 26 and transmitted therethrough to be changed to linearly polarized light having the vibration direction orthogonal to the transmission axis 153 of the polarizing plate 24. Then, the light is input to the polarizing plate 24 and absorbed by the plate, thereby causing the sub-pixels to provide a dark display.

In the formation region of the light scatterer 29, the thickness of the liquid crystal layer 50 is smaller than the thickness thereof in the other regions. In the present embodiment, the thickness thereof is made approximately half the thickness “d” of the liquid crystal layer 50 in the other regions. However, in the liquid crystal device of the horizontal electric field mode, an effective drive voltage changes depending on the thickness of the liquid crystal layer. Thus, it is conceivable that a phase difference value given to transmitted light by the liquid crystal layer may change to be greater than the amount of a change in the thickness thereof. In such a case, the thickness of the liquid crystal layer above the light scatterer 29 may be adjusted by adjusting the height of the insulating protrusion 29a of the light scatterer 29 such that a phase difference in the formation region thereof is a half (λ/4) of the phase difference in the other regions.

The liquid crystal device 100 of the present embodiment employs the structure in which the reflective polarizing layer (reflective common electrode 19r) is disposed partially in the sub-pixel region. The simple arrangement allows high-contrast reflection and transmission displays. In addition, since the light scatterers 29 are disposed on the reflective common electrode 19r, a part of reflected light can be scattered. This can secure reflective luminance in a panel front direction and also can prevent the deterioration of reflection display visibility due to the direct reflection of outside light in the reflection display region R. Therefore, excellent visibility can be obtained in both of the reflection and transmission displays.

There is previously known a structure for giving a light scattering property to a reflective layer in a reflective liquid crystal device. For example, the reflective layer with the light scattering property can be obtained by forming the reflective layer on a resin film with an uneven surface. Thus, applying such an uneven structure to the reflective common electrode 19r can ensure manufacturing of a reflective polarizing layer with the light scattering property. However, in order to manufacture the reflective common electrode 19r used in the present invention, as described above, it is necessary to form grid-shaped narrow lines having a minute line width of a few tens nanometers, although it is difficult to form narrow lines with a precise line width on the uneven surface of the resin film mentioned above. Meanwhile, in the present embodiment, after formation of the reflective common electrode 19r, the insulating protrusion 29a is formed directly thereon or formed on another layer disposed thereon and covered by the reflective layer 29b, thereby forming the light scatterer 29. Accordingly, since the reflective common electrode 19r can be formed on the flat surface, narrow lines forming the reflective polarizing layer can be formed with a precise line width, thereby enabling formation of the reflective polarizing layer having a good polarization selectivity. Additionally, since the light scatterer 29 can be formed on the flat reflective common electrode 19r, the height of the insulating protrusion 29a controlling the thickness of the liquid crystal layer can be precisely adjusted. Thus, without causing visual contrast deterioration, the light scattering property can be given to the reflection display.

Furthermore, in the liquid crystal device 100 of the present embodiment, the thickness of the liquid crystal layer is made uniform both in the transmission display region T as a main display section and the region performing display by using the reflective common electrode 19r in the reflection display region R. Accordingly, there occurs no drive voltage difference between those regions, so that display state does not differ between the reflection display and the transmission display.

Furthermore, since the reflective common electrode 19r performing reflection display is included in the TFT array substrate 10, it can be prevented that outside light is reflected by a metal wire or the like formed on the TFT array substrate 10 in addition to the TFT 30, thereby deteriorating display quality. Still furthermore, since the pixel electrode 9 is made of the transparent conductive material, it can be prevented that the pixel electrode 9 diffusely reflects outside light input to the TFT array substrate 10 through the liquid crystal layer 50. Therefore, excellent visibility can be obtained.

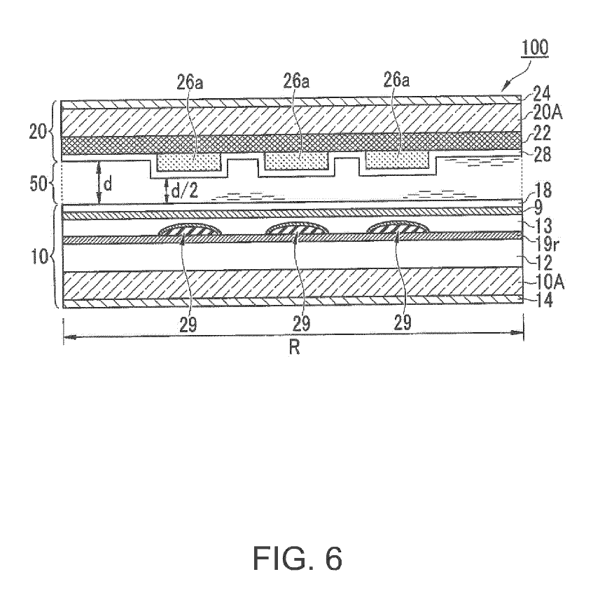

The first embodiment hereinabove has described the case in which the phase difference plate 26 is disposed between the substrate main body 20A of the opposing substrate 20 and the polarizing plate 24. Alternatively, a phase difference layer having the same mechanism as that of the phase difference plate 26 may be provided on a side of the opposing substrate 20 facing the liquid crystal layer 50. FIG. 6 shows a partial sectional structure of the reflection display region R when a plurality of internal phase difference layers 26a are formed on the side of the opposing substrate 20 facing the liquid crystal layer 50. In the structural example of the drawing, the internal phase difference layers 26a are formed selectively on the side of the substrate facing the liquid crystal layer 50. Thus, a surface portion of the opposing substrate 20 positioned in the formation region of each of the internal phase difference layers 26a is protruded toward the liquid crystal layer 50. In other words, each internal phase difference layer 26a is formed so as to serve as the layer for adjusting the thickness of the liquid crystal layer above each of the light scatterers 29.

In addition, as described above, when the liquid crystal layer thickness is adjustable by using the thickness of the internal phase difference layer 26a, the height of the light scatterers 29 may be reduced, as shown in the TFT array substrate 10 of FIG. 6, thereby smoothing the unevenness of the surface of the TFT array substrate 10 due to the shape of the light scatterers 29. In this manner, since the pixel electrode 9 can be formed on the relatively flat electrode insulating film 13, the pixel electrode 9 can be formed with a good precision.

When the internal phase difference layers 26a are formed on the side of the opposing substrate 20 facing the liquid crystal layer, the surface of the opposing substrate 20 may be flattened by forming a flattening film for covering the internal phase difference layers 26a. In this case, by using the TFT array substrate 10 formed as shown in FIG. 3, the light scatterers 29 may be used as the layer for adjusting the thickness of the liquid crystal layer.

### Second Embodiment

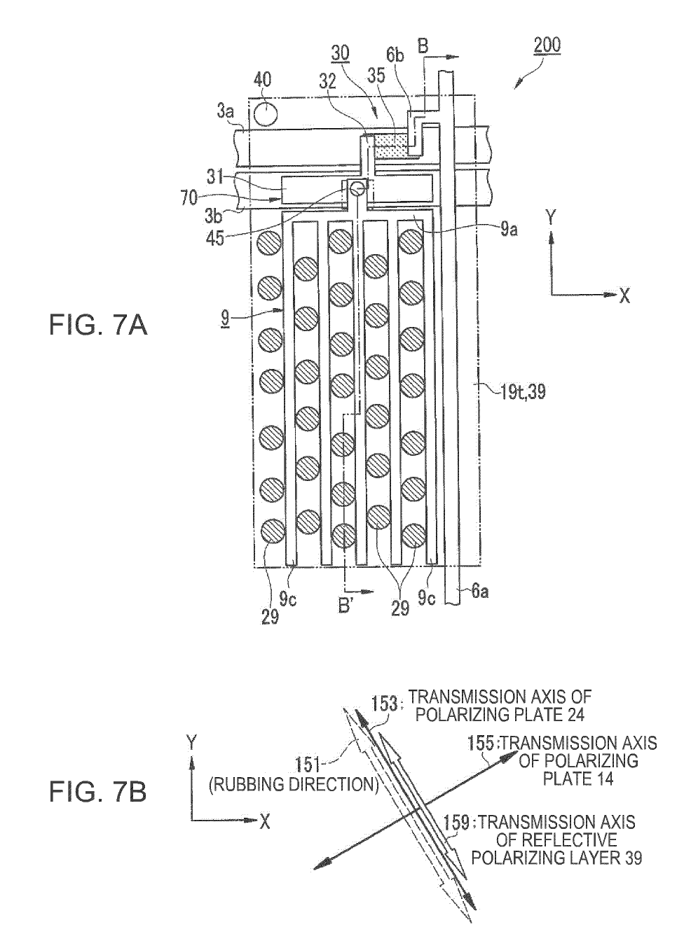

Next will be described a liquid crystal device according to a second embodiment of the invention by referring to FIGS. 7A, 7B to FIG. 10.

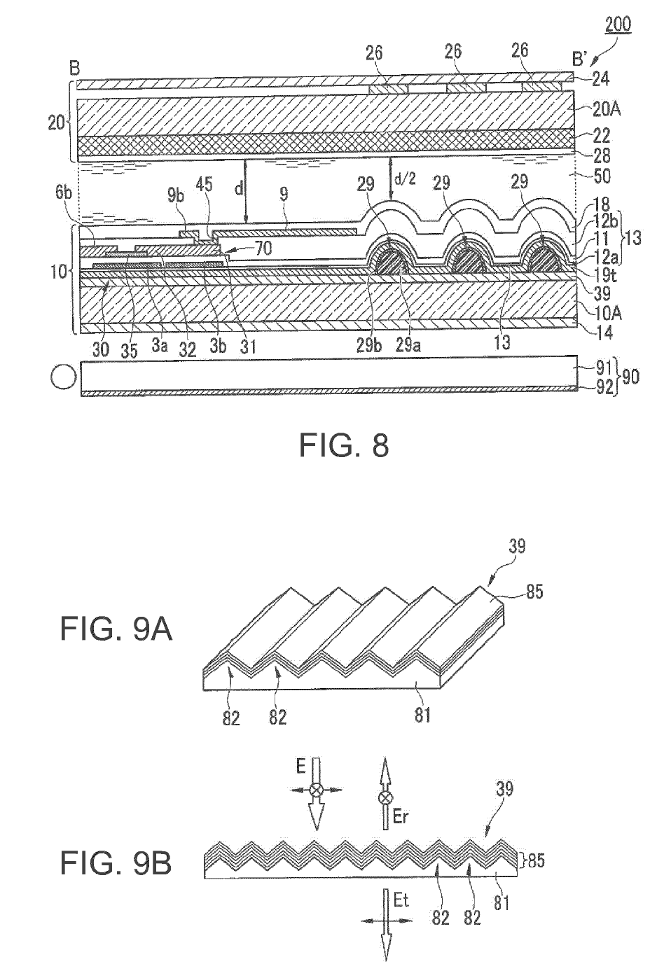

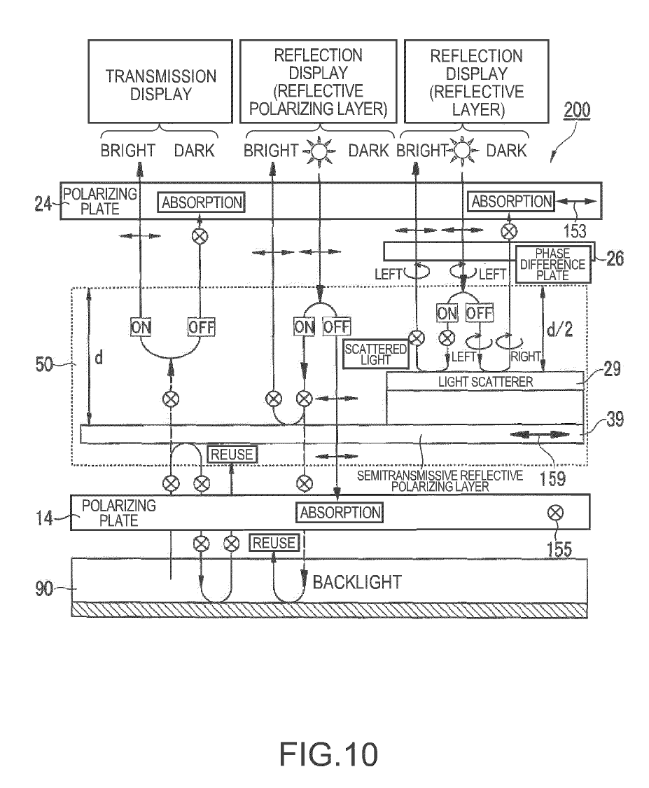

FIG. 7A is a plan view showing an arbitrary single sub-pixel region in a liquid crystal device 200 of the second embodiment. FIG. 7B is an illustrative view showing the arrangement of optical axes of optical elements included in the liquid crystal device 200. FIG. 8 is a sectional view taken along line B-B′ of FIG. 7A. FIGS. 9A and 9B are illustrative views showing a structure of a reflective polarizing layer and a mechanism thereof. FIG. 10 is an illustrative view showing an operation of the liquid crystal device 200 of the second embodiment.

The basic structure of the liquid crystal device 200 of the present embodiment is the same as that of the above first embodiment. FIGS. 7A and 7B correspond to FIGS. 2A and 2B, respectively, in the first embodiment. FIG. 8 and FIG. 10 correspond to FIG. 3 and FIG. 5, respectively, in the first embodiment. Accordingly, in each of the drawings referred to in the present embodiment, the same reference numerals are given to the same components as those in the liquid crystal device 100 shown in FIGS. 1 to 5 of the first embodiment and thus descriptions thereof will be omitted hereinafter.

As shown in FIGS. 7A and 7B, in the sub-pixel region of the liquid crystal device 200 of the present embodiment, there are provided the pixel electrode (first electrode) 9 and the TFT 30 electrically connected to the pixel electrode 9 with the capacitance electrode 31 interposed therebetween. The amorphous silicon semiconductor layer 35 included in the TFT 30 is electrically connected to the drain electrode 32 extended from the capacitance electrode 31 and the source electrode 6b branched from the data line 6a that is extended in the Y-axis direction shown in FIG. 7B. The scan line 3a is arranged on a back surface side of the semiconductor layer 35 and extended in the X-axis direction in the drawing. The scan line 3a forms the gate electrode of the TFT 30 at the position thereof overlapping with the semiconductor layer 35. The capacitance electrode 31 and the capacitance line 3b two-dimensionally overlaps therewith and extends parallel to the scan line 3a form the storage capacitance 70 of the sub-pixel region.

Additionally, in the sub-pixel region shown in FIG. 7A are formed a reflective polarizing layer 39 and the common electrode (second electrode) 19 both having an approximately planar and continuous shape.

In the sectional structure shown in FIG. 8, the liquid crystal device 200 includes the TFT array substrate (first substrate) 10 and the opposing substrate (second substrate) 20 that are opposed to each other while sandwiching the liquid crystal layer 50 therebetween. On a back surface side (lower surface side in the drawing) of the TFT array substrate 10 is provided the backlight 90. Since the opposing substrate 20 is formed in the same manner as in the first embodiment, the detailed description thereof will be omitted.

On the substrate main body 10A formed as a base body of the TFT array substrate 10 is formed the planar and continuous reflective polarizing layer 39. On the reflective polarizing layer 39 are dispersed the light scatterers 29, which are the approximately dome-shaped (approximately hemispherical) protrusions. In order to cover the reflective polarizing layer 39 and the light scatterers 29, there is formed the transparent common electrode 19t made of a transparent conductive material such as ITO.

Additionally, a first interlayer insulating film 12a is formed to cover the transparent common electrode 19t. On the first interlayer insulating film 12a are formed the scan line 3a and the capacitance line 3b. In order to cover the lines 3a and 3b, there is formed the gate insulating film 11, on which there are formed the semiconductor layer 35, the source electrode 6b (data line 6a) and the drain electrode 32 (capacitance electrode 31), both of which are electrically connected to the semiconductor layer 35. Additionally, a second interlayer insulating film 12b is formed to cover the semiconductor layer 35, the source electrode 6b, the drain electrode 32, and the like. Then, the pixel electrode 9 is formed on the second interlayer insulating film 12b.

Thus, in the liquid crystal device 200 of the second embodiment, the electrode insulating film 13 includes the first interlayer insulating film 12a, the gate insulating film 11 and the second interlayer insulating film 12b.

The pixel contact hole 45 is formed penetrating through the second interlayer insulating film 12b to reach the capacitance electrode 31. The contact portion 9b (pixel electrode 9) and the capacitance electrode 31 are electrically connected to each other via the pixel contact hole 45. The alignment film 18 is formed so as to cover the pixel electrode 9.

FIG. 9A is a perspective view of the reflective polarizing layer 39. FIG. 9B is a side surface view for illustrating the mechanism of the reflective polarizing layer 39.

As shown in FIG. 9A, the reflective polarizing layer 39 included in the liquid crystal device 200 of the present embodiment includes a prism array 81 made of a thermally hardened transparent resin such as acrylic resin, or an optically hardened transparent resin formed on the substrate main body 10A, and a dielectric interference film 85 formed by alternately laminating a plurality of dielectric films, which are two kinds of dielectric films having different refractive indexes.

The prism array 81 is comprised of a plurality of triangular columns (prisms) each having a protruded portion 82 formed by two inclined planes. The protruded portions 82 are continuously and periodically arranged to form the prism array 81 having a triangular-wave shaped section. The dielectric interference film 85 is a prism-shaped dielectric multilayer film in which dielectric films made of two kinds of materials having different refractive indexes are alternately laminated so as to follow the shape of the inclined planes with the protruded portions 82. For example, the dielectric interference film 85 may be obtained by alternately laminating a TiO₂ film and a SiO₂ film into seven layers.

An upper surface of the dielectric interference film 85 is coated with a resin layer to be flattened, although not shown in FIGS. 9A and 9B. The dielectric interference film 85 formed on the prism array as described above has anisotropic light propagation characteristics. When a light (natural light) E is input from the upper surface side of FIG. 9B, the dielectric interference film 85 reflects a polarized component parallel to an extending direction of the protruded portions 82 and transmits a polarized component vertical to the extending direction thereof. In short, the reflective polarizing layer 39 shown in FIG. 7A and FIG. 8 has a reflection axis parallel to the extending direction of the protruded portions 82 and a transmission axis vertical thereto.

In the liquid crystal device 200 of the present embodiment, linearly polarized light parallel to the reflection axis of the reflective polarizing layer 39 is input from the backlight 90 to be used for transmission display. As shown in FIG. 7B, the transmission axis 155 of the polarizing plate 14 is arranged to be orthogonal to a transmission axis 159 of the reflective polarizing layer 39, whereby the transmission axis 155 thereof is arranged approximately parallel to the reflection axis (the extending direction of the protruded portions 82) of the reflective polarizing layer 39. Additionally, the transmission axis 153 of the polarizing plate 24 and the rubbing direction 151 of the alignment films 18 and 28 are arranged parallel to the transmission axis 159 of the reflective polarizing layer 39.

A single dielectric film included in the dielectric interference film 85 has a thickness of approximately 10 to 100 nm and an entire thickness of the interference film 85 ranges approximately 300 to 1 μm. The protruded portions 82 of the prism array 81 each have a height of 0.5 to 3 μm, and a pitch between adjacent protruded portions 82 ranges approximately 1 to 6 μm. The dielectric film may be made of TiO₂, SiO₂, Ta₂O₅ or Si, for example.

A lamination pitch between the dielectric films included in the dielectric interference film 85 and the pitch between the protruded portions 82 are appropriately adjusted to an optimum value according to intended characteristics of the reflective polarizing layer 39. Specifically, in the reflective polarizing layer 39 formed as above, according to the number of laminated layers of the dielectric films included in the dielectric interference film 85, a transmittance (reflectance) thereof can be controlled. Reducing the number of the laminated layers thereof can increase the transmittance of linearly polarized light parallel to the reflection axis (the extending direction of the protruded portions 82) and can decrease the reflectance thereof. Meanwhile, when the number of the laminated dielectric films exceeds a predetermined number thereof, almost all of the linearly polarized light parallel to the transmission axis is reflected. Thus, the reflective polarizing layer 39 of the present embodiment is set such that adjusting the dielectric interference film 85 allows the layer 39 to reflect approximately 70 percent of linearly polarized incident light parallel to the reflection axis and transmit the remaining approximately 30 percent thereof.

Next, the operation of the liquid crystal device 200 will be described with reference to FIG. 10. In FIG. 10, as components necessary to describe the operation thereof below, there are shown the polarizing plate 24, the phase difference plate 26, the liquid crystal layer 50, the light scatterer 29, the reflective polarizing layer 39, the polarizing plate 14 and the backlight 90 sequentially from the upper side in the drawing (panel display surface side).

First, a description will be given of a “transmission display” (transmission mode) shown in the left side of FIG. 10.

In the liquid crystal device 200, light emitted from the backlight 90 is transmitted through the polarizing plate 14, thereby being changed to linearly polarized light having a vibration direction parallel to the transmission axis 155 of the polarizing plate 14 to be input to the reflective polarizing layer 39. The incident light is linearly polarized light parallel to the reflection axis (an optical axis orthogonal to the transmission axis 159) of the reflective polarizing layer 39. Then, a part (approximately 30 percent) of the incident light is transmitted through the reflective polarizing layer 39 to be input to the liquid crystal layer 50. When the liquid crystal layer 50 is in the ON state (where a selected voltage is applied between the pixel electrode 9 and the transparent common electrode 19t), the liquid crystal layer 50 gives a predetermined phase difference (λ/2) to the incident light. Thereby, the incident light is changed to linearly polarized light having the vibration direction parallel to the transmission axis 153 of the polarizing plate 24 to be transmitted through the polarizing plate 24. As a result, the light transmitting therethrough is visually recognized as display light, thereby causing the sub-pixels to provide a bright display.

Meanwhile, when the liquid crystal layer 50 is in the OFF state (where any selected voltage is not applied), light transmitted through the reflective polarizing layer 39 is input to the liquid crystal layer 50 to reach the polarizing plate 24 while maintaining its polarized state. Then, the incident light is absorbed by the polarizing plate 24 having an absorption axis parallel to the incident light (the optical axis orthogonal to the transmission axis 153), thereby causing the sub-pixels to provide a dark display.

Approximately 70 percent of the light input to the reflective polarizing layer 39 through the polarizing plate 14 is reflected by the reflective polarizing layer 39. The reflected light is again transmitted through the polarizing plate 14 to be returned to the backlight 90. The returned light is reflected by the reflecting plate 92 of the backlight 90 and reused as light directed toward the liquid crystal panel again. Thus, actually, the amount of light transmitted through the reflective polarizing layer 39 exceeds the transmittance thereof. Therefore, the use efficiency of illumination light is not significantly reduced.

Additionally, in the liquid crystal device of the present embodiment, a part of the linearly polarized light transmitting through the reflective polarizing layer 39 is input to a back surface side of each of the light scatterers 29 (a side thereof toward the substrate main body 10A). When the insulating protrusion 29a of the light scatterer 29 is made of a transparent material, the above incident light is also reflected by the reflective layer 29b of the light scatterer 29 to be returned to the backlight 90 and reused like the light reflected by the reflective polarizing layer 39.

Next, a description will be given of a “reflection display (reflective polarizing layer)” shown in the center of FIG. 10.

In the reflection display using the reflective polarizing layer 39, a light input from the upper side (outside) of the polarizing plate 24 is transmitted therethrough, whereby the light is changed to linearly polarized light having the vibration direction parallel to the transmission axis 153 of the polarizing plate 24 to be input to the liquid crystal layer 50. At that time, when the liquid crystal layer 50 is in the ON state, the liquid crystal layer 50 gives the predetermined phase difference (λ/2) to the incident light, which, in turn, is input to the reflective polarizing layer 39. As shown in FIG. 7B and FIG. 9, the reflective polarizing layer 39 has the transmission axis 159 parallel to the transmission axis 153 of the polarizing plate 14 and the reflection axis orthogonal thereto. Thus, a part (approximately 70 percent) of the light input to the reflective polarizing layer 39 through the liquid crystal layer 50 in the above ON state is reflected while maintaining its polarized state, and the rest (approximately 30 percent) of the light is transmitted through the reflective polarizing layer 39. The light reflected by the reflective polarizing layer 39 is again input to the liquid crystal layer 50. The light is then returned to the polarized state it had upon incidence (the state of being the linearly polarized light parallel to the transmission axis of the polarizing plate 24) by the mechanism of the liquid crystal layer 50 to be input to the polarizing plate 24. As a result, the reflected light transmitted therethrough is visually recognized as display light, thereby causing the sub-pixels to provide a bright display.

Meanwhile, a linearly polarized light component input from the liquid crystal layer 50 in the ON state is transmitted through the reflective polarizing layer 39. Then, the light component is transmitted through the polarizing plate 14 having the transmission axis 155 parallel to the polarizing direction thereof to be input to the backlight 90. Next, the light input to the backlight 90 is reflected by the reflecting plate 92 to be returned toward the liquid crystal layer 50. A part of the returned light is transmitted through the reflective polarizing layer 39 to be input to the liquid crystal layer 50 and reused as display light for the above bright display. Accordingly, in the liquid crystal device 200 of the embodiment, the reflectance of the linearly polarized light parallel to the reflection axis in the reflective polarizing layer 39 is set to approximately 70 percent. The light reflected toward the backlight 90 through the reflective polarizing layer 39 can also be used as display light, so that a bright reflection display can be obtained.

On the other hand, when the liquid crystal layer is in the OFF state, a light input to the liquid crystal layer 50 from the polarizing plate 24 is input to the reflective polarizing layer 39 while maintaining its polarized state and then is transmitted through the reflective polarizing layer 39 having the transmission axis 159 parallel to the incident light. Thereafter, the light is absorbed by the polarizing plate 14 having the absorption axis parallel to the light, thereby causing the sub-pixels to provide a dark display.

Next, in the reflection display shown as “reflection display (reflective layer)” on the right side of FIG. 10, a light input to the liquid crystal panel from the upper side (panel display surface side) of the polarizing plate 24 is transmitted through the polarizing plate 24, whereby the light is changed to linearly polarized light having the vibration direction parallel to the transmission axis 153 of the polarizing plate 24. Next, the light is transmitted through the phase difference plate 26 to be changed to counterclockwise circularly polarized light and then input to the liquid crystal layer 50. In this case, in the formation region of each of the light scatterers 29, due to the thickness of the insulating protrusion 29a, the thickness of the liquid crystal layer 50 is partially reduced to be approximately a half (d/2) of the thickness “d” of the liquid crystal layer 50 in the other regions. Accordingly, when the liquid crystal layer 50 is in the ON state, the phase difference given to the above incident light by the liquid crystal layer 50 is λ/4 as a half wavelength of the light input to the reflective polarizing layer 39. Thereby, the above incident light is changed to linearly polarized light having the vibration direction orthogonal to the transmission axis 153 of the polarizing plate 24 to be input to the light scatterer 29 (reflective layer 29b). The linearly polarized light is reflected while maintaining its polarized state to become light scattered by the protruded shape of the reflective layer 29b. Thereafter, the above incident light is again input to the liquid crystal layer 50 to be changed to counterclockwise circularly polarized light by the mechanism of the liquid crystal layer 50 and then input to the phase difference plate 26. Next, the light transmitted therethrough is changed to linearly polarized light having the vibration direction parallel to the transmission axis 153 of the polarizing plate 24 to be transmitted through the polarizing plate 24. As a result, the reflected light transmitted through the plate is visually recognized as display light, thereby causing the sub-pixels to provide a bright display.

Meanwhile, when the liquid crystal layer 50 is in the OFF state, the light input to the liquid crystal layer 50 from the phase difference plate 26 is input to the light scatterer 29 while maintaining its polarized state to be reflected by the reflective layer 29b. At that time, a traveling direction of the incident light as the counterclockwise circularly polarized light is reversed. Thus, the rotation direction of the light when viewed from the polarizing plate 24 is reversed, whereby the light turns to clockwise circularly polarized light and is input again to the liquid crystal layer 50. Then, the light is transmitted through the liquid crystal layer 50 to be input to the phase difference plate 26. After transmitting therethrough, the light turns to linearly polarized light having the vibration direction orthogonal to the transmission axis 153 of the polarizing plate 24. Then, the linearly polarized light is input to the polarizing plate 24 and absorbed by the plate, causing the sub-pixels to provide a dark display.

In the formation region of each of the light scatterers 29, the thickness of the liquid crystal layer is smaller than the thickness thereof in the other regions. In the present embodiment, the thickness thereof is made to be approximately a half of the thickness “d” thereof in the other regions. However, in the liquid crystal device of the horizontal electric field mode, an effective drive voltage changes depending on the thickness of the liquid crystal layer. Thus, it is conceivable that a value of the phase difference given to transmitted light by the liquid crystal layer may change to be greater than the amount of a change in the thickness thereof. In that case, by adjusting the height of the insulating protrusion 29a of the light scatterer 29, it is possible to adjust the thickness of the liquid crystal layer above the light scatterer 29 in such a manner that the phase difference in the formation region thereof becomes a half (λ/4) of the phase difference in the other regions.

In the liquid crystal device 200 structured as above, on an underlayer side below the pixel electrode 9 (on the substrate main body 10A), there is formed the reflective polarizing layer 39 in the planar and continuous shape. Thus, it is unnecessary to match the position of the reflective polarizing layer 39 with the position of the sub-pixel region, so that there is an advantage of producing the device in a simple and easy process at a low cost. Additionally, as in the present embodiment, by employing the structure in which the reflective polarizing layer 39 is formed on the substrate main body 10A rather than on the semiconductor layer 35, it is possible to reduce a depth of the pixel contact hole 45 electrically connecting a wiring layer with the semiconductor layer 35 formed thereon to the pixel electrode 9, thereby increasing electrical reliability necessary as a conductive connection structure via the pixel contact hole 45. Furthermore, an opening diameter of the pixel contact hole 45 can be made small, which can suppress the alignment disorder of liquid crystal molecules around the pixel contact hole 45.

Furthermore, in the present embodiment, the light scatterers 29 are formed on a side of the transparent common electrode 19t toward the substrate main body 10A. With the arrangement, it is easy to make uniform the thickness of the insulating film between the pixel electrode 9 and the transparent common electrode 19t in the sub-pixel region. This can reduce the distribution of electric field intensity in the sub-pixel region, thereby increasing the equality of display luminance.

Furthermore, like the liquid crystal device 100 of the first embodiment, since the light scatterers 29 are arranged in the sub-pixel region, reflected light is scattered, thereby improving the luminance and visibility of reflection display. Additionally, since the reflective polarizing layer 39 for performing reflection display is arranged on the TFT array substrate 10, it is unnecessary to arrange the TFT array substrate 10 on the display surface side of the liquid crystal device. This can prevent diffused reflection of outside light due to a metal wiring or the like, as seen in the case of the TFT array substrate 10 arranged on the display surface side. Therefore, the liquid crystal device can provide an excellent visibility.

In the present embodiment, the transparent common electrode 19t is formed directly on the reflective polarizing layer 39. It is only necessary for the transparent common electrode 19t to be disposed at a position spaced apart from the pixel electrode 9 by interposing at least a single layer of an insulating film therebetween. For example, the transparent common electrode 19t may be formed on a wiring layer between the gate insulating film 11 and the first interlayer insulating film 12a or on a wiring layer between the second interlayer insulating film 12b and the gate insulating film 11. Additionally, after forming the transparent common electrode 19t on the second interlayer insulating film 12b, the pixel electrode 9 may be formed on the electrode insulating film formed to cover the electrode 19t.

In the present embodiment, also, for better understanding of the drawings, the light scatterers 29 and the pixel electrode 9 are shown so as not to two-dimensionally overlap with each other. However, obviously, a part of the pixel electrode 9 may be placed on the light scatterers 29.

Moreover, it is also obvious that the structure shown in FIG. 6 may also be employed in the present embodiment.

### Third Embodiment

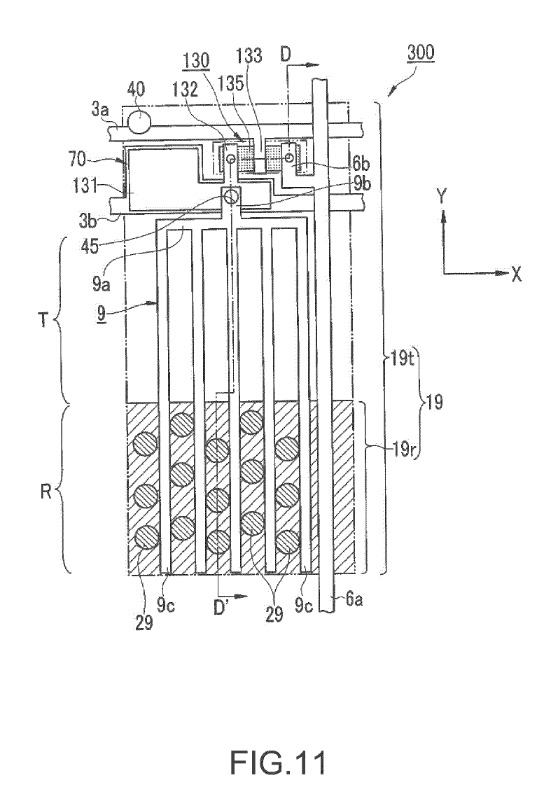

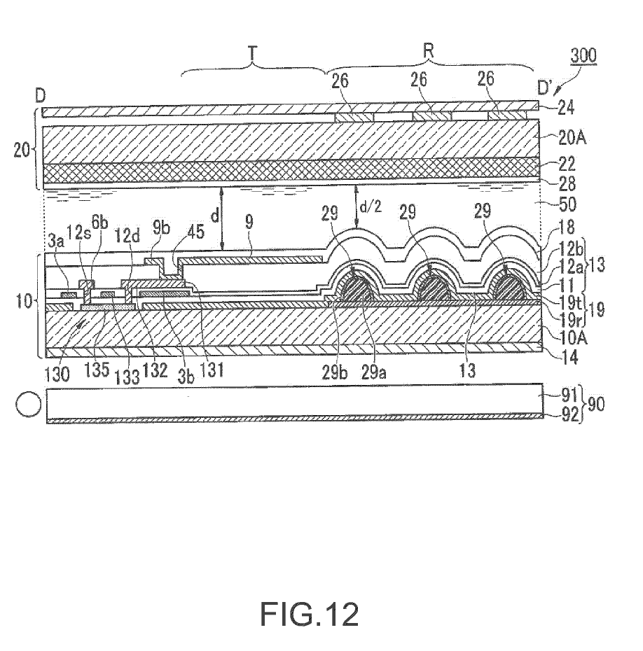

Next will be described a liquid crystal device according to a third embodiment of the invention with reference to FIGS. 11 and 12.

FIG. 11 is a plan view showing an arbitrary single sub-pixel region in a liquid crystal device 300 of the third embodiment. FIG. 12 is a sectional view taken along line D-D′ of FIG. 11.

Instead of the amorphous silicon TFT 30 used in the liquid crystal device 100 of the first embodiment, the liquid crystal device 300 of the present embodiment uses a top-gated polysilicon TFT 130. The basic structure of the device 300, except for a structure relating to a pixel switching element, is the same as that of the liquid crystal device 100 of the first embodiment.

FIG. 11 corresponds to FIG. 2A in the first embodiment. Similarly, FIG. 12 corresponds to FIG. 3. Accordingly, throughout the drawings referred to in the present embodiment, the same reference numerals are given to the same components as those in the liquid crystal device 100 of the first embodiment shown in FIGS. 1 to 5 and thus the description thereof will be omitted below.

As shown in FIG. 11, in the sub-pixel region of the liquid crystal device 300 of the present embodiment are provided the pixel electrode (first electrode) 9, the common electrode (second electrode) 19 and the TFT 130 electrically connected to the pixel electrode 9 by a capacitance electrode 131 interposed therebetween.

A polysilicon semiconductor layer 135 included in the TFT 130 is formed so as to have a longitudinal rectangular shape in a planar view in the extending direction of the scan line 3a. A first end portion of the semiconductor layer 135 is electrically connected to a drain electrode 132 extending from the capacitance electrode 131 via a drain contact hole. Meanwhile, a second end portion of the semiconductor layer 135 toward the data line 6a is electrically connected to a source electrode 6b branched from the data line 6a extending in the Y-axis direction shown in FIG. 11, via a source contact hole.

Near the semiconductor layer 135 is formed the scan line 3a extending in the direction (X-axis direction) orthogonal to the data line 6a. A part of the scan line 3a is branched to form a gate electrode 133, which is extended to the semiconductor layer 135. The gate electrode 133 is arranged intersecting with the semiconductor layer 135 at the center of the layer. Between the scan line 3a and the pixel electrode 9 is formed the capacitance line 3b extending parallel to the scan line 3a. A part of the capacitance line 3b has an enlarged width in the sub-pixel region, where the capacitance electrode 131 is arranged so as to two-dimensionally overlap with the enlarged width region to form the storage capacitance 70 at a overlapping position thereof. On the capacitance electrode 131 is arranged the contact portion 9b of the pixel electrode 9. The pixel electrode 9 is electrically connected to the capacitance electrode 131 via the pixel contact hole 45.

The common electrode 19 includes the reflective common electrode 19r having a strip shape and extending over the plurality of sub-pixel regions in the extending direction of the scan line 3a and the transparent common electrode 19t formed in the planar and approximately continuous shape to cover the reflective common electrode 19r. In the planar region with the pixel electrode 9 formed thereon, the formation region of the reflective common electrode 19r is referred to as the “reflection display region R”, and a region outside the reflective common electrode 19r is referred to as the “transmission display region T”.

In the sectional structure shown in FIG. 12, the liquid device 300 includes the TFT array substrate (first substrate) 10 and the opposing substrate (second substrate) 20, which are opposed to each other by sandwiching the liquid crystal layer 50 therebetween. On the back surface side of the TFT array substrate 10 (on a lower surface side in the drawing) is provided the backlight 90. Since the structure of the opposing substrate 20 is the same as that in the first embodiment, a detailed description thereof will be omitted.

On the substrate main body 10A forming a base body of the TFT array substrate 10 is partially formed the reflective common electrode 19r, which is the reflective polarizing layer produced by forming many fine slit opening portions on a reflective metal film made of aluminum or the like. Additionally, there is also formed the semiconductor layer 35 made of a polysilicon film having a rectangular shape in a planar view. On the reflective common electrode 19r are dispersed the plurality of light scatterers 29, which are approximately dome-shaped (approximately hemispherical) protrusions having a light-reflective surface. In a region on the substrate main body 10A except for the formation region of the semiconductor layer 135 is formed the transparent common electrode 19t to cover the light scatterers 29 and the reflective common electrode 19r. The transparent common electrode 19t is made of a transparent conductive material such as ITO.

The gate insulating film 11 is formed to cover the semiconductor layer 135 and the transparent common electrode 19t. On the gate insulating film 11 are formed the scan line 3a, the gate electrode 133 and the capacitance line 3b. The first interlayer insulating film 12a is formed on the gate insulating film 11 to cover the scan line 3a, the gate electrode 133 and the capacitance line 3b. On the first interlayer insulating film 12a are formed the source electrode 6b (data line 6a), the drain electrode 132 and the capacitance electrode 131. A source contact hole 12s and a drain contact hole 12d are provided penetrating through the first interlayer insulating film 12a and the gate insulating film 11 to reach the semiconductor layer 135. The source electrode 6b and the semiconductor layer 135 are electrically connected to each other via the source contact hole 12s. Via the drain contact hole 12d, the drain electrode 132 is electrically connected to the semiconductor layer 135.

In this case, on the polysilicon film forming the semiconductor layer 135, impurities such as phosphorous and boron are introduced in a region except for a region (channel region) two-dimensionally overlapping with the gate electrode 133 to form a source region and a drain region. The impurity-introduced regions are electrically connected to the source electrode 6b and the drain electrode 132.

The second interlayer insulating film 12b is formed to cover the source electrode 6b, the drain electrode 132 and the capacitance electrode 131. On the second interlayer insulating film 12b is formed the pixel electrode 9. The pixel contact hole 45 is formed penetrating through the second interlayer insulating film 12b to reach the capacitance electrode 131. Via the pixel contact hole 45, the contact portion 9b of the pixel electrode 9 is electrically connected to the capacitance electrode 131. On the pixel electrode 9 is formed the alignment film 18.

The arrangement of optical axes in the liquid crystal device 300 of the present embodiment is the same as that of the optical axes in the liquid crystal device 100 of the first embodiment shown in FIG. 2B. Specifically, with respect to the extending direction (Y-axis direction) of the strip electrode portions 9c, the rubbing direction of the alignment films 18 and 28 forms an angle of approximately 30 degrees. The transmission axis of the reflective common electrode 19r is parallel to the rubbing direction. Additionally, the transmission axis of the polarizing plate 14 of the TFT array substrate 10 is arranged in a direction orthogonal to the rubbing direction, whereas the transmission axis of the polarizing plate 24 of the opposing substrate 20 is arranged in a direction parallel to the rubbing direction.

The liquid crystal device 300 having the optical axes arranged as above can operate in the same manner as in the liquid crystal device 100 of the first embodiment described with reference to FIG. 5. Thus, in both of the reflection display and the transmission display, a bright and high contrast display can be obtained.

In the liquid crystal device 300 of the present embodiment structured as above, the TFT 130 including the polysilicon semiconductor layer is used as a pixel-switching element. The TFT 130 has a high carrier mobility and can operate at a high speed. Thus, the liquid crystal device 300 can easily be applied also to a high-resolution liquid crystal device requiring a high-speed switching operation for pixels. Additionally, since the present embodiment uses the top-gated TFT 130, as shown in FIG. 12, the common electrode 19 can be provided on the same layer as the semiconductor layer 135 is arranged. Accordingly, while using the same layer structure as that of the TFT array substrate without the common electrode 19 provided thereon, there can be obtained the FFS-mode liquid crystal device. Thus, the liquid crystal device 300 can be manufactured without forming any new interlayer insulating film to add a wiring layer, which is advantageous in that the liquid crystal device 300 can be easily manufactured at a low cost.

Furthermore, like the liquid crystal device of each of the first and the second embodiments described above, the light scatterers 29 are arranged on the reflective common electrode 19r. Accordingly, the scattering of reflected light can effectively improve display luminance and visibility. Moreover, since the reflective common electrode 19r is disposed on the TFT array substrate 10 to perform reflection display, it is unnecessary to arrange the TFT array substrate 10 on the display surface side of the liquid crystal display. This can prevent diffused reflection of outside light due to a metal wire or the like, as seen when TFT array substrate 10 is arranged on the display surface side. Therefore, the liquid crystal device can have an excellent visibility.

Additionally, also in the present embodiment, the light scatterers 29 are formed on the side of the transparent common electrode 19t toward the substrate main body 10A. This allows the thickness of the insulating film between the pixel electrode 9 and the transparent common electrode 19t to be easily made uniform in the sub-pixel region. It can reduce the electric-field intensity distribution in the sub-pixel region, thereby increasing the equality of display luminance. Moreover, it is obvious that the present embodiment can employ the structure shown in FIG. 6.

### Fourth Embodiment

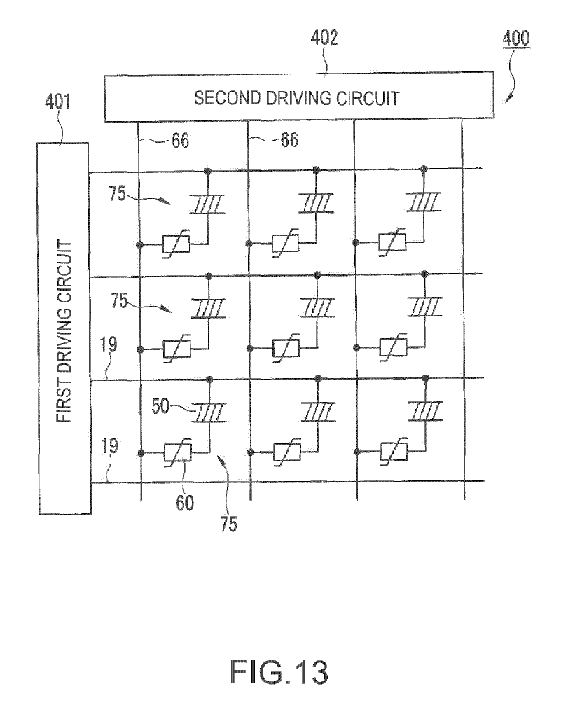

Next will be described a liquid crystal device according to a fourth embodiment of the invention with reference to FIGS. 13 to 15.

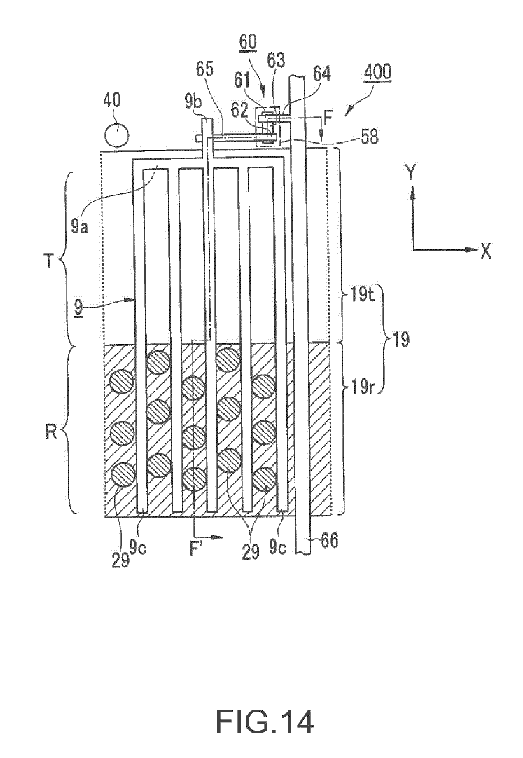

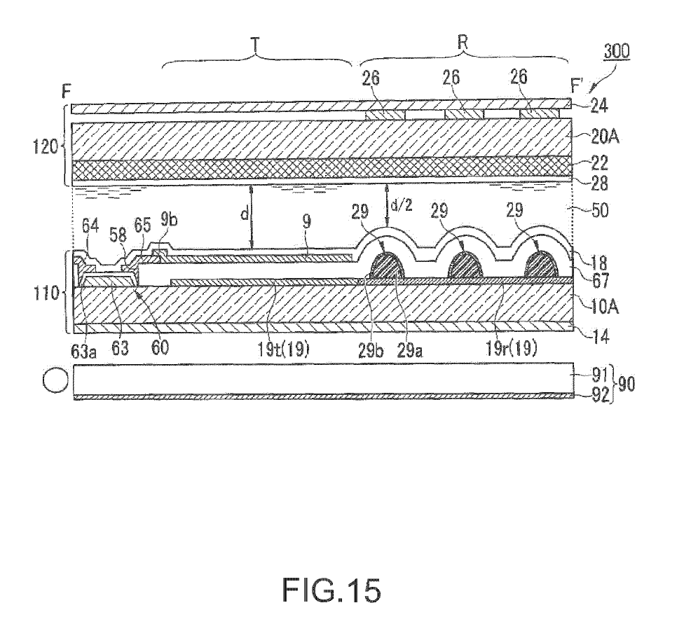

FIG. 13 shows a circuit diagram of a plurality of sub-pixel regions arranged in a matrix, which are included in a liquid crystal device 400 of the fourth embodiment. FIG. 14 is a plan view showing an arbitrary single sub-pixel region included in the liquid crystal device 400 of the present embodiment. FIG. 15 is a sectional view taken along line F-F′ of FIG. 14.

The liquid crystal device 400 of the present embodiment is an active-matrix liquid crystal device using a thin film diode (TFD) element as a pixel-switching element. Additionally, like the first to the third embodiments, the liquid crystal device 400 has the FFS-mode electrode structure. The basic structure excluding a structure relating to the pixel-switching element is the same as that in the liquid crystal device of each of the first to the third embodiments. Throughout the drawings referred to in the present embodiment, the same reference numerals are given to the same components as those in the liquid crystal device 100 of the first embodiment shown in FIGS. 1 to 5 and the description thereof will be omitted below.

As shown in FIG. 13, the liquid crystal device 400 includes a plurality of sub-pixels 75 arranged in a matrix in a planar view, a plurality of first wires (common electrodes) 19 and a plurality of second wires 66, both of which are extended in an mutually intersecting direction to partition the sub-pixels 75. Additionally, the liquid crystal device 400 includes a first driving circuit 401 and a second driving circuit 402. The first wires 19 are electrically connected to the first driving circuit 401, and the second wires 66 are electrically connected to the second driving circuit 402. In the structure, a drive signal is sent from each of the first and the second driving circuits 401 and 402 via each of the first and the second wires 19 and 66 to be supplied to each of the sub-pixels 75. The sub-pixel 75 includes a TFD element 60 and a liquid crystal display element (liquid crystal capacitance) 50, which are formed between the first and the second wires 19 and 66.

As shown in FIG. 14, in the sub-pixel region are provided the pixel electrode (first electrode) 9, the common electrode (second electrode) 19 and the TFD element 60. The common electrode (first wire) 19 is a strip conductive film extending in the X-axis direction. The element wire (second element) 66, which intersects with the common electrode 19 and extends in the Y-axis direction, is arranged along an edge of the pixel electrode 9.

The TFD element 60 includes an electrode film 63 having a longitudinal rectangular shape in the extending direction of the element wire 66, a wire-branched portion 64 branched and extended from the element wire 66, and an electrode wire 65 extended parallel to the wire-branched portion 64 along the base end portion 9a of the pixel electrode 9. The TFD element 60 further includes a first element portion 61 formed at a position where the electrode film 63 intersects with the wire-branched portion 64 and a second element portion 62 formed at a position where the electrode film 63 intersects with the electrode wire 65. The TFD element 60 has a so-called back-to-back structure in which the first and the second element portions 61 and 62 are connected in the back-to-back (electrically reversed) manner.

An end portion of the electrode wire 65, which is not positioned on the TFD element 60, intersects with the contact portion 9b of the pixel electrode 9 to be electrically connected thereto, whereby the TFD element 60 is interposed between the element wire 66 and the pixel electrode 9. Furthermore, in the sub-pixel region is provided the columnar spacer 40.

In a partial sectional structure shown in FIG. 15, the liquid crystal device 400 is formed such that an element substrate (first substrate) 110 is opposed to an opposing substrate (second substrate) 120 while sandwiching the liquid crystal layer 50 therebetween. The opposing substrate 120 has the same structure as that of the opposing substrate 20 of the first embodiment and thus the description thereof will be omitted below.

The element substrate 110 includes the substrate main body 10A made of a translucent substrate such as a glass or quartz substrate as a base body. On the substrate main body 10A, there are formed the electrode film 63 made of tantalum or an alloy thereof and the common electrode 19. A surface of the electrode film 63 is coated with an element insulating film 63a made of a tantalum oxide film. The common electrode 19 is partitioned into the transparent common electrode 19t made of a transparent conductive material such as ITO and the reflective common electrode 19r mainly made of a light-reflective metal (e.g. aluminum) film in the sub-pixel region. In the entire image display region, the transparent common electrode 19t and the reflective common electrode 19r are formed parallel to each other and extended in a strip shape over the plurality of sub-pixel regions. The reflective common electrode 19r is a reflective polarizing layer having the same structure as that of the reflective common electrode 19r of the first embodiment.

On the reflective common electrode 19r are dispersed the light scatterers 29, which are approximately dome-shaped (approximately hemispherical) protrusions each having the light-reflective surface. An interlayer insulating film (electrode insulating film) 67 is formed to cover the light scatterers 29 and the common electrode 19. The interlayer insulating film 67 is made of an organic insulating material (e.g. silicon oxide) or a resin material (e.g. acrylic). The electrode film 63 is arranged in an opening portion 58 provided penetrating through the interlayer insulating film 67. On the interlayer insulating film 67 are formed the wire-branched portion 64 (element wire 66), the electrode wire 65 and the pixel electrode 9. An end of each of the wire-branched portion 64 and the electrode wire 65 is extended from a surface of the interlayer insulating film 67 to an inside of the opening portion 58 to intersect with the electrode film 63, thereby forming a metal-insulator-metal (MIM) structure of the first and the second element portions 61 and 62 at the intersecting position. The alignment film 18 is formed to cover the pixel electrode 9, the wire-branched portion 64, the electrode wire 65 and the like.

The arrangement of optical axes in the liquid crystal device 400 of the present embodiment is the same as that of optical axes in the liquid crystal device 100 of the first embodiment shown in FIG. 2B. Specifically, with respect to the extending direction (Y-axis direction) of the strip electrode portions 9c, the rubbing direction of the alignment films 18 and 28 forms an angle of approximately 30 degrees. The transmission axis of the reflective common electrode 19r is parallel to the rubbing direction thereof. Additionally, the transmission axis of the polarizing plate 14 of the element substrate 10 is arranged orthogonal to the rubbing direction, whereas the transmission axis of the polarizing plate 24 of the opposing substrate 120 is arranged parallel to the rubbing direction.

The liquid crystal device 400 with the optical axes arranged as above can operate in the same manner as the liquid crystal device 100 of the first embodiment described with reference to FIG. 5. Thus, the liquid crystal device 400 can provide bright and high-contrast reflection and transmission displays.

The liquid crystal device 400 structured as above includes the TFD element 60 as the pixel switching element. Thus, it can be manufactured by a simple and easy process, which is advantageous in terms of a manufacturing cost. Additionally, the pixel electrode 9 and the common electrode 19 are opposed to each other with the insulating film interposed therebetween in a substrate thickness direction, which allows the opposing region thereof to serve as a storage capacitance, thereby easily maintaining a voltage of the pixel electrode 9. Therefore, the liquid crystal device 400 can be suitably applied also to a high-resolution liquid crystal device having a small liquid crystal capacitance.

Furthermore, similarly to the liquid crystal devices according to the first and the second embodiments, the light scatterers 29 are arranged on the reflective common electrode 19r to scatter reflected light, thereby improving display luminance and visibility. Moreover, since the refection common electrode 19r is disposed on the element substrate 110 to perform reflection display, it is unnecessary to arrange the element substrate 10 on the display surface side of the liquid crystal device. This can prevent diffused reflection of outside light due to a metal wire or the like, as seen when the element substrate 10 is arranged on the display surface side. Accordingly, the liquid crystal device 400 can have an excellent visibility.

Additionally, in the present embodiment, the transparent common electrode 19t may be formed in an approximately planar and continuous shape to cover the light scatterers 29 and the reflective common electrode 19r. The formation allows the thickness of the insulating film between the pixel electrode 9 and the transparent common electrode 19t to be easily made uniform in the sub-pixel region. As a result, the electrical field intensity distribution can be reduced within the sub-pixel region, thereby increasing the equality of display luminance. Moreover, it is obvious that the present embodiment can employ the opposing substrate with the internal phase difference layer, as shown in FIG. 6. In this case, obviously, the surface of the element substrate 110 facing the liquid crystal layer may be flattened.

### Fifth Embodiment

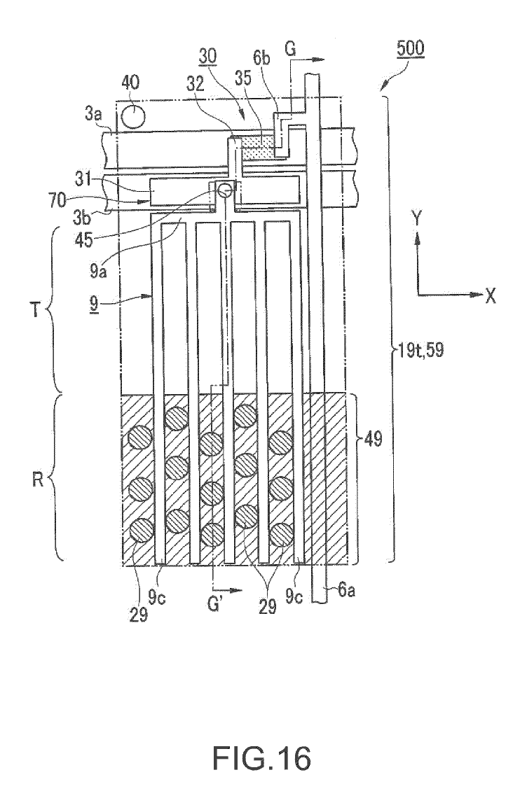

Next will be described a liquid crystal device according to a fifth embodiment of the invention with reference to FIGS. 16 to 18.

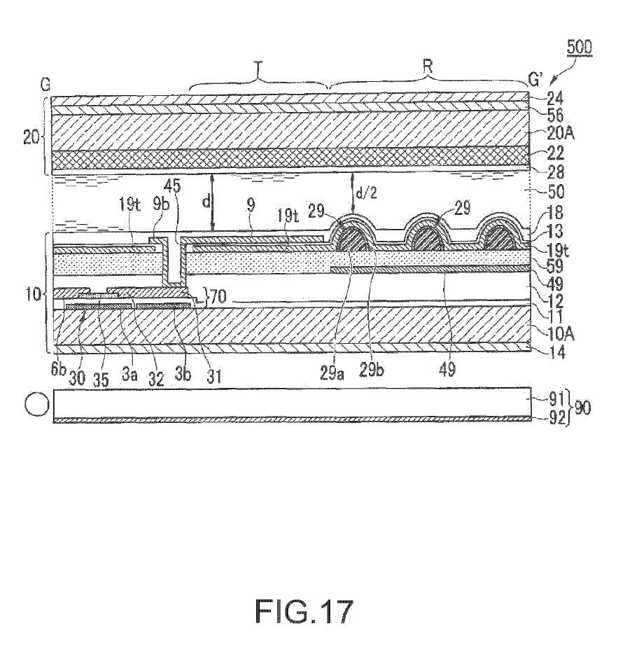

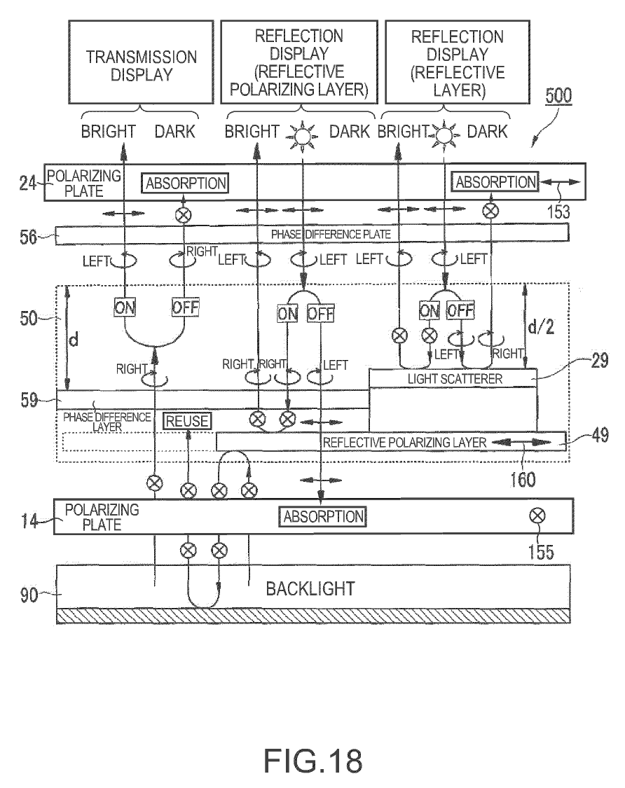

FIG. 16 is a plan view showing an arbitrary single pixel region in a liquid crystal device 500 of the fifth embodiment. FIG. 17 is a sectional view taken along line G-G′ of FIG. 16. FIG. 18 is an illustrative view of an operation of the liquid crystal device 500 of the fifth embodiment.

The basic structure of the liquid crystal device 500 of the present embodiment is the same as that of the above first embodiment. FIG. 16 corresponds to FIG. 2A in the first embodiment. FIG. 17 and FIG. 18, respectively, correspond to FIG. 3 and FIG. 5, respectively, in the first embodiment. Accordingly, throughout the drawings referred to in the present embodiment, the same reference numerals are given to the same components as those in the liquid crystal device 100 shown in FIGS. 1 to 5 of the first embodiment and thus descriptions thereof will be omitted below.

As shown in FIG. 16, in the sub-pixel region of the liquid crystal device 500 of the present embodiment, there are provided the pixel electrode (first electrode) 9, the transparent common electrode (second electrode) 19t and the TFT 30 electrically connected to the pixel electrode 9 with the capacitance electrode 31 interposed therebetween.

The amorphous silicon semiconductor layer 35 included in the TFT 30 is electrically connected to the drain electrode 32 extended from the capacitance electrode 31 and the source electrode 6b branched from the data line 6a extended in the Y-axis direction in FIG. 16. The scan line 3a arranged on a back surface side of the semiconductor layer 35 and extended in the X-axis direction in the drawing forms a gate electrode of the TFT 30 at a position two-dimensionally overlapping with the semiconductor layer 35. The capacitance electrode 31 and the capacitance line 3b two-dimensionally overlapping therewith and extending parallel to the scan line 3a form the storage capacitance 70 in the sub-pixel region.

In FIG. 16, a reflective polarizing layer 49 is formed partially in the sub-pixel region. Additionally, in the region, there is also formed an approximately planar and continuous phase difference layer 59, which is similar to the transparent common electrode (second electrode) 19t.

In a sectional structure shown in FIG. 17, the liquid crystal device 500 includes the TFT array substrate (first substrate) 10 and the opposing substrate (second substrate) 20, which are opposed to each other while sandwiching the liquid crystal layer 50 therebetween. The backlight 90 is provided on the back surface side of the TFT array substrate 10 (the lower surface side in the drawing). Additionally, the opposing substrate 20 of the present embodiment includes a film-like phase difference plate 56 arranged between the substrate main body 20A and the polarizing plate 24.

On the substrate main body 10A forming a base body of the TFT array 10 is formed the gate insulating film 11 that covers the scan line 3a and the capacitance line 3b. On the gate insulating film 11 are formed the semiconductor layer 35, the source electrode 6b (data line 6a) electrically connected to the semiconductor layer 35 and the drain electrode 32 (capacitance electrode 31). The interlayer insulating film 12 is formed to cover the semiconductor layer 35, the source electrode 6b, the drain electrode 32 and the like. Partially on the interlayer insulating film 12 is formed the reflective polarizing layer 49. The reflective polarizing layer 49 may be the reflective polarizing layer made of the metal film with the slit opening portion as shown in FIG. 4, or the reflective polarizing layer made of the prism-shaped dielectric multilayer film as shown in FIG. 9.

On the interlayer insulating film 12 including the surface of the reflective polarizing layer 49 is formed the approximately planar and continuous phase difference layer 59. Similarly to the phase difference plate 56 of the opposing substrate 20, the phase difference layer 59 gives the phase difference of approximately λ/4 to transmitted light and can be made of polymer liquid crystal molecules or the like aligned in a predetermined direction. Regarding the phase difference layer 59 and the phase difference plate 56, the arrangement of the optical axes thereof is adjusted to compensate for each other.

In a region of the phase difference layer 59 corresponding to the formation region of the reflective polarizing layer 49 are dispersed the light scatterers 29 as the approximately dome-shaped (approximately hemispherical) protrusions. In order to cover the light scatterers 29, there is formed the transparent common electrode 19t made of a transparent conductive material such as ITO on the phase difference layer 59 in the approximately planar and continuous shape. In order to cover the transparent common electrode 19t, there is formed the electrode insulating film 13, which has the pixel electrode 9 formed thereon. The alignment film 18 is formed so as to cover the pixel electrode 9.

The arrangement of the optical axes of optical elements included in the liquid crystal device 500 of the present embodiment is the same as that in the first embodiment. Specifically, as shown in FIG. 18, the arrangement is made such that the transmission axis 155 of the polarizing plate 14 is orthogonal to a transmission axis 160 of the reflective polarizing layer 49. Additionally, the transmission axis 153 of the polarizing plate 24 and the rubbing direction of the alignment films 18 and 28 are arranged parallel to the transmission axis 160 thereof.

Next will be described the operation of the liquid crystal device 500 structured as above with reference to FIG. 18. FIG. 18 shows only components necessary for the description among those shown in FIG. 7, where there are shown the polarizing plate 24, the phase difference plate 56, the liquid crystal layer 50, the light scatterer 29, the phase difference layer 59, the reflective polarizing layer 49, the polarizing plate 14 and the backlight 90 sequentially from the upper side (panel display surface side).

First, a description will be given of a “transmission display” (transmission mode) using the light transmission region (transmission display region T) outside the reflective polarizing layer 49.

As shown in the “transmission display” on the left side of FIG. 18, in the liquid crystal device 500, light emitted from the backlight 90 is transmitted through the polarizing plate 14 and changed to linearly polarized light having the vibration direction parallel to the transmission axis 155 of the polarizing plate 14 to be input to the liquid crystal panel. The light input thereto is then input to the phase difference layer 59 to be given the predetermined phase difference (λ/4). Thereafter, the light is changed to a clockwise circularly polarized light to be input to the liquid crystal layer 50. When the liquid crystal layer 50 is in the ON state (where a selected voltage is applied between the pixel electrode 9 and the transparent common electrode 19t), the above incident light is given the predetermined phase difference (λ/2) by the liquid crystal layer 50 to be changed to counterclockwise circularly polarized light and input to the phase difference layer 56. The light input thereto is, in turn, given the predetermined phase difference (λ/4) by the phase difference plate 56 to be changed to a linearly polarized light having the vibration direction parallel to the transmission axis 153 of the polarizing plate 24. As a result, the light transmitted through the polarizing plate 24 is visually recognized as display light, thereby causing the sub-pixels to provide a bright display.

Meanwhile, when the liquid crystal layer 50 is in the OFF state (where any selected voltage is not applied), the light input to the liquid crystal layer 50 from the phase difference layer 59 reaches the phase difference plate 56 while maintaining its polarized state and then transmits therethrough to be changed to linearly polarized light having the vibration direction parallel to the absorption axis (optical axis orthogonal to the transmission axis 153) of the polarizing plate 24. Next, the linearly polarized light input to the polarizing plate 24 is absorbed by the plate, which causes the sub-pixels to provide a dark display.

Additionally, among light transmitted through the polarizing plate 14, a light input to the reflective polarizing layer 49 is reflected by the reflective polarizing layer 49 having a reflection axis parallel to the linearly polarized light. Thus, the light is returned to the backlight 90 instead of being input to the liquid crystal layer 50. The reflected light is the linearly polarized light having the vibration direction parallel to the transmission axis of the polarizing plate 14. Accordingly, it is transmitted through the polarizing plate 14 to reach the reflecting plate 92 of the backlight 90, resulting in being repeatedly reflected between the reflecting plate 92 and the reflective polarizing layer 49. The light repeatedly reflected is input to the light transmission region of the liquid crystal panel, resulting in being reused as display light for transmission display. Consequently, this can improve a light use efficiency of the backlight 90 and can increase luminance in transmission display.

Next will be described a reflection display using the reflective polarizing layer 49.

In the reflection display of a part shown as “reflection display (reflective polarizing layer)” at a center of FIG. 18, a light input from the upper side (panel display surface side) of the polarizing plate 24 to the liquid crystal panel is transmitted through the polarizing plate 24 and changed to linearly polarized light parallel to the transmission axis 153 of the polarizing plate 24 to be input to the phase difference plate 56. Next, the incident light transmitted therethrough is changed to counterclockwise circularly polarized light to be input to the liquid crystal layer 50. In this situation, when the liquid crystal layer 50 is in the ON state, the incident light is given the predetermined phase difference (λ/2) by the liquid crystal layer 50 and then changed to circularly polarized light having a clockwise direction opposite to the direction of incidence to be input to the phase difference layer 59. The clockwise circularly polarized light input thereto is, in turn, changed to linearly polarized light having a vibration direction parallel to the reflection axis (an axis orthogonal to the transmission axis 160) of the reflective polarizing layer 49 to be input to the reflective polarizing layer 49 and reflected while maintaining its polarized state. The reflected light input again to the phase difference layer 59 is changed to clockwise circularly polarized light by the phase difference layer 59 to be input to the liquid crystal layer 50. Due to the mechanism of the liquid crystal layer 50, the light is changed to counterclockwise circularly polarized light to be input to the phase difference plate 56. Then, the phase difference plate 56 changes the incident light to linearly polarized light having the vibration direction parallel to the transmission axis of the polarizing plate 24 to input it to the polarizing plate 24. The reflected light transmitting through the plate is visually recognized as display light, thereby causing the sub-pixels to provide a bright display.

Meanwhile, when the liquid crystal layer 50 is in the OFF state, the light (counterclockwise circularly polarized light) input to the liquid crystal layer 50 from the polarizing plate 24 through the phase difference plate 56 is input to the phase difference layer 59 while maintaining its polarized state. The light is changed to a linearly polarized light having the vibration direction parallel to the transmission axis of the reflective polarizing layer 49 to be input to the reflective polarizing layer 49. Then, after transmitting therethrough, the light is absorbed by the polarizing plate 14 having an absorption axis parallel to the light (a transmission axis orthogonal thereto), thereby causing the sub-pixels to provide a dark display.

When the liquid crystal layer 50 is in the OFF state, an outside light input to the transmission display region T outside the reflective polarizing layer 49 is changed to linearly polarized light having the vibration direction orthogonal to the transmission axis of the polarizing plate 14 to be input to the polarizing plate 14 and absorbed by the plate. Accordingly, the liquid crystal device 500 of the present embodiment does not cause an unnecessary outside light reflection.

Next, as shown in the part indicated as “reflection display (reflective layer)” on the right side of FIG. 18, a light input to the liquid crystal panel from the upper side (panel display surface side) of the polarizing plate 24 is transmitted through the polarizing plate 24 to be changed to linearly polarized light having the vibration direction parallel to the transmission axis 153 of the polarizing plate 24. Then, the light is further transmitted through the phase difference plate 56 to be changed to counterclockwise circularly polarized light and input to the liquid crystal layer 50. In this situation, when the liquid crystal layer 50 is in the ON state, the incident light is changed to linearly polarized light having the vibration direction orthogonal to the transmission axis 153 of the polarizing plate 24 to be input to the light scatterer 29 (reflective layer 29b). The linearly polarized light is reflected while maintaining its polarized state to become light scattered by the protruded shape of the reflective layer 29b. Thereafter, the reflected light is input again to the liquid crystal layer 50 and changed to counterclockwise circularly polarized light by the mechanism of the liquid crystal layer 50 to be input to the phase difference plate 26. Next, after transmitting therethrough, the light is changed to linearly polarized light having the vibration direction parallel to the transmission axis 153 of the polarizing plate 24 and transmitted through the polarizing plate 24. Thereby, the reflected light transmitted therethrough is visually recognized as display light, thereby causing the sub-pixels to provide a bright display.

Meanwhile, when the liquid crystal layer 50 is in the OFF state, the light input to the liquid crystal layer 50 from the phase difference plate 56 is input to the light scatterer 29 while maintaining its polarized state and reflected by the reflective layer 29b. At that time, since a traveling direction of the incident light as counterclockwise circularly polarized light is reversed, the rotation direction thereof when viewed from the polarizing plate 24 is reversed and the light is changed to clockwise circularly polarized light to be input again to the liquid crystal layer 50. Then, the light is transmitted through the liquid crystal layer 50 to be input to the phase difference plate 56. After transmitting therethrough, it is changed to linearly polarized light having the vibration direction orthogonal to the transmission axis 153 of the polarizing plate 24 to be input to the polarizing plate 24 and then absorbed by the plate. It results in causing the sub-pixels to provide a dark display.

The liquid crystal device 500 of the present embodiment employs the structure in which the reflective polarizing layer 49 is disposed partially in the sub-pixel region. Thus, with the simple and easy structure, high-contrast reflection and transmission displays can be obtained. Additionally, since the light scatterers 29 are disposed on the reflective polarizing layer 49, a part of reflected light can be scattered. This can secure reflection luminance in the panel front direction, as well as can prevent the reduction of visibility in reflection display due to the direct reflection of outside light in the reflection display region R. Accordingly, excellent visibility can be obtained in both of the reflection and transmission displays.

Additionally, in the present embodiment, as shown in FIG. 17, the phase difference layer 59 is disposed on the side of the TFT array substrate 10 toward the liquid crystal layer 50. In the structure, since the phase difference layer is internally arranged, the phase difference plate 56 having approximately the same size as that of the substrate main body 20A can be used in the opposing substrate 20. In other words, it is unnecessary to adjust the position of the phase difference plate to coincide with the positions of the light scatterers 29. Thus, as compared to the liquid crystal device of the first embodiment, the present embodiment can provide a more advantageous structure in terms of manufacturability.

The light scatterers 29 may be formed on an arbitrary wire layer of the TFT array substrate 10 only if they are disposed toward the liquid crystal layer 50 more than the reflective polarizing layer 49. If the phase difference layer 59 is arranged toward the liquid crystal layer 50 more than the light scatterers 29, it is necessary to remove the phase difference layer 59 on (or above) the light scatterers 29. Alternatively, in the present embodiment, the approximately planar and continuous phase difference layer 59 is formed so as to cover the reflective polarizing layer 49, and the light scatterers 29 are formed on the phase difference layer 59. Accordingly, it is unnecessary to remove the phase difference layer on the light scatterer 29. As a result, the liquid crystal device 500 can provide excellent manufacturability, even in the formation process of the phase difference layer.

Internally arranging the phase difference layer 59 as in the liquid crystal device 500 of the present embodiment is also suitably applicable to the liquid crystal device 200 of the second embodiment. In this case, in the structure shown in FIG. 8, the phase difference layer may be arranged between the transparent common electrode 19t along with the light scatterers 29 and the reflective polarizing layer 39. In the opposing substrate 20, instead of the island-shaped phase difference plate 26, the phase difference plate 56 having a sheet-like shape may be arranged.

Furthermore, when the liquid crystal device of the third embodiment shown in FIG. 12 includes the internally arranged phase difference layer, the phase difference layer may be arranged so as to cover the reflective common electrode 19r in the structure shown in FIG. 12 and the light scatterers 29 and the transparent common electrode 19t may be formed on the phase difference layer.

### Electronic Apparatus

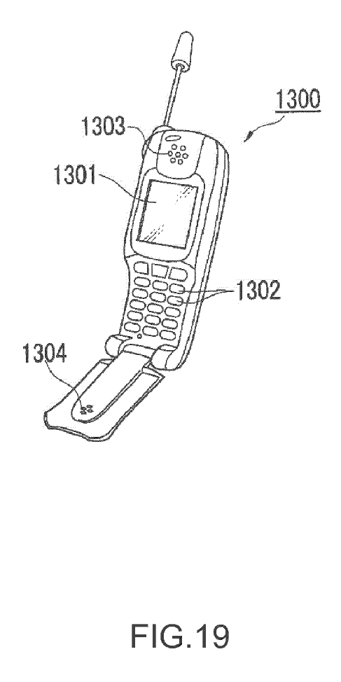

FIG. 19 is a perspective view of a mobile phone as an example of an electronic apparatus that includes the liquid crystal device of any one of the embodiments in a display section thereof. A mobile phone 1300 includes the liquid crystal device of any one of the embodiments as a small display section 1301, together with a plurality of operation buttons 1302, a receiver aperture 1303, and a speaker aperture 1304.

In addition to the above mobile phone, as an image display device, the liquid crystal device of any one of the embodiments may be suitably applied to an electronic book, a personal computer, a digital still camera, a liquid crystal television set, a view-finder type or monitor direct-view-type video tape recorder, a car navigation device, a pager, an electronic organizer, an electronic calculator, a word processor, a work station, a video phone, a point of sale (POS) terminal, a device equipped with a touch panel, or the like. Any of the electronic apparatuses can provide transmission and reflection displays with a high luminance, a high contrast and a wide view angle.

What is claimed is:

1. A liquid crystal device of semi-transmissive reflective type, comprising:
a first substrate and a second substrate opposed to each other;
a liquid crystal layer interposed therebetween;
a pixel region having a reflection display region and a transmission display region;
a first electrode having a plurality of strip electrode portions electrically connected to each other;
a second electrode included in the first substrate and facing the first electrode to produce an electric field between the first and the second electrodes;
an electrode insulating film interposed between the first and the second electrodes, the electrodes and the electrode insulating film being arranged in a side of the first substrate toward the liquid crystal layer;
a reflective polarizing layer for selectively reflecting a predetermined polarized light component of incident light;
a light scatterer for scattering reflected light; and
a layer for adjusting a thickness of the liquid crystal layer to make the thickness thereof in a light scatterer formation region different from the thickness thereof in a light scatterer non-formation region, the reflective polarizing layer, the light scatterer and the liquid-crystal-layer thickness adjusting layer being provided in the reflection display region.

2. The liquid crystal device according to claim 1, wherein the light scatterer includes an insulating protrusion formed in the reflection display region and a reflecting film formed on a surface of the insulating protrusion.

3. The liquid crystal device according to claim 1, wherein the light scatterer serves also as the liquid-crystal-layer thickness adjusting layer.

4. The liquid crystal device according to claim 1, wherein the light scatterer is formed in a non-formation region of the reflective polarizing layer in the reflection display region.

5. The liquid crystal device according to claim 1, wherein the light scatterer is formed partially on a side of the reflective polarizing layer toward the liquid crystal layer.

6. The liquid crystal device according to claim 1, wherein a difference between a phase difference of the liquid crystal layer in the light scatterer formation region and a phase difference thereof in the light scatterer non-formation region is approximately ¼ of a wavelength λ of a light input to the pixel region.

7. The liquid crystal device according to claim 6, wherein a phase difference layer for giving the phase difference of approximately λ/4 to transmitted light is formed in a region of the second substrate that two-dimensionally overlaps with the light scatterer.

8. The liquid crystal device according to claim 6, wherein a phase difference plate for giving the phase difference of approximately λ/4 to transmitted light is provided in the second substrate on a side of the liquid crystal layer, whereas a phase difference layer for giving the phase difference of approximately λ/4 to the transmitted light is formed in the first substrate to be disposed toward the liquid crystal layer more than the reflective polarizing layer.

9. The liquid crystal device according to claim 1, wherein the thickness of the liquid crystal layer in the light scatterer formation region is smaller than the thickness thereof in the light scatterer non-formation region.

10. The liquid crystal device according to claim 9, wherein the thickness of the liquid crystal layer in the light scatterer formation region is approximately ½ of the thickness thereof in the reflection display region in the light scatterer non-formation region.

11. The liquid crystal device according to claim 1, wherein the thickness of the liquid crystal layer in the transmission display region is approximately the same as the thickness thereof in the light scatterer non-formation region of the reflection display region.

12. The liquid crystal device according to claim 1, wherein the reflective polarizing layer is a metal film having a fine slit opening portion.

13. The liquid crystal device according to claim 1, wherein the reflective polarizing layer is a dielectric multilayer film formed by laminating a plurality of dielectric films each having a prism shape.

14. A liquid crystal device of semi-transmissive reflective type, comprising:
a first substrate and a second substrate opposed to each other;
a liquid crystal layer interposed therebetween;
a pixel region having a reflection display region and a transmission display region;
a first electrode having a plurality of strip electrode portions electrically connected to each other;
a second electrode provided in the first substrate and facing the first electrode to produce an electric field between the first and the second electrodes;
an electrode insulating film interposed between the first and the second electrodes, the electrodes and the electrode insulating film being arranged in a side of the first substrate toward the liquid crystal layer;
a reflective polarizing layer for selectively reflecting a predetermined polarized light component of incident light; and
a reflective layer for reflecting the incident light, the reflective polarizing layer and the reflective layer being formed to be partitioned in the reflection display region, and a thickness of the liquid crystal layer in a formation region of the reflective polarizing layer being different from the thickness thereof in a formation region of the reflective layer.

15. The liquid crystal device according to claim 14, wherein a dielectric protrusion as a layer for adjusting the thickness of the liquid crystal layer is formed in the first substrate so as to correspond to the formation region of the reflective layer.

16. The liquid crystal device according to claim 14, wherein the reflective layer is a light scatterer that produces scatteredly reflected light.

17. An electronic apparatus comprising the liquid crystal device according to claim 1.
